(19) United States
(12) Patent Application Publication
(10) Pub. No.: US 2004/0223499 A1
(43) Pub. Date: Nov. 11, 2004

(54) Communications networks with converged services

(75) Inventors: David M. Sanderson, Plymouth, MN (US); Reid Knuttila, Minneapolis, MN (US)

Correspondence Address: Iain A. Mclntyre, Altera Law Group, Suite 100, 6500 City West Parkway, Minneapolis, MN, 55344-7704, US

(73) Assignee: Onvoy, Inc., Minneapolis, MN

(21) Appl. No.: 10/457,904

(22) Filed: Jun. 10, 2003

Related U.S. Application Data
(62) Division of application No. 10/431,664, filed on May 8, 2003.

(51) Int. Cl. H04L 12/28

(52) U.S. Cl. 370/395.52

(57) ABSTRACT

A communications network provides one or more shared services, such as voice or video, to customers over a respective virtual private network (VPN). At the same time, each customer may have its own private data VPN for handling private company data. The shared service VPN permits users from different customers to communicate directly over the shared service VPN. Trust and security are established at the edge of the network, as the information enters from the customer's site. As a result, no additional security measures are required within the shared service VPN for the communications between users. This architecture results in a fast, high quality, shared service.

### FIELD OF THE INVENTION

The present invention is directed generally to communications, and more particularly to a communications network that provides voice, video, Internet and private data services.

### BACKGROUND

Communications systems for companies having a number of sites have historically been complex. One of the reasons for the complexity is the simultaneous requirement for open communications, such as telephony and video services, with entities outside the company, and for privacy of company information.

Private networks, for carrying private information, were originally built either to reduce costs or because there was no public service available. The initial private networks were made up of leased circuits, initially analog, and then later digital. Companies typically built private networks for data communication purposes and separate networks for telecommunications or voice traffic. This was required because the networks were specialized for the media they were transporting. FIG. 1 illustrates one example private network 100, in which the company headquarters 102 is connected directly to each branch office 104. One of the problems with such a network is that none of the branch offices can communicate with each other directly. As a result, if the connection at the headquarters 102 is broken, for example due to equipment failure, then no office can communicate with another office. Also, private networks based on leased circuits were very expensive and very few companies could afford them.

Consequently, Public Data Network companies arose, to lease capacity on their networks. These companies used link layer technologies, such as X.25, Frame Relay, and eventually asynchronous transfer mode (ATM), to create virtual circuits across their network, thus allowing their client's sites to be connected together. Such virtual circuits are often referred to as virtual private networks (VPNs), and are commonly defined as a network whereby customer connectivity amongst multiple sites is deployed on a shared infrastructure with the same policies as a private network. The customers were charged either for the amount of traffic that traversed the virtual circuit and/or the capacity, also referred to as bandwidth, that was provided to the customer.

An example of a VPN 200, based on X.25, Frame Relay or ATM is schematically shown in FIG. 2. This VPN differs in two main respects from that illustrated in FIG. 1. First, the VPN is physically formed on a shared communications network 206. Second, the VPN provides greater connectivity between sites. Not only are all satellite offices 204 connected to the headquarter site 202, but some of the satellite offices 204 are connected to each other. Thus, the greater redundancy in the connections of the VPN permits satellite offices 204 to communicate even if the connection at the headquarters 202 is broken.

Another method of creating VPNs is by using a layer 3 technology. Internet Protocol (IP) is the predominant layer 3 protocol and tunneling protocols like Generic Routing Encapsulation (GRE) and IPsec can be used to create virtual connections between sites on an IP based network such as the Internet. In the case of GRE, a packet destined for another site is encapsulated inside another IP packet whose destination address is the address of the router attached to the destination site and whose source address is the address of the router that encapsulated the original packet. This explained further with reference to FIG. 3. The source host 302 generates a packet 304 that contains fields for the addresses of the source host, SH, and the destination host, DH. The packet is sent to a source router 306 that adds to the packet addresses for the source router, SR, and the destination router, DR, to form the encapsulated packet 308. The encapsulated packet 308 is then sent through the Internet 310 to the destination router 312, which strips out the router addresses to reproduce the original packet 314 that is then directed to the destination host 316. The IPsec protocol is similar to GRE but uses a different encapsulation method and provides authentication and encryption of the payload.

Layer 2 technologies (such as X.25, Frame Relay and ATM) and Layer 3 technologies are known as the Overlay Model of creating VPNs. It is called overlay because the underlying network is independent of the virtual network using it: the virtual network has no knowledge of the structure of the physical network. One problem with the overlay model, however, is that it does not scale well as the number of sites increases. In order for each site to be able to send traffic to another site on the VPN, without the traffic passing through an intermediate site, a full mesh of virtual circuits must be built. This requires that n(n−1)/2 bi-directional virtual circuits be built, where n is the number of sites. As the number of sites, or nodes, increases, the number of virtual circuits grows exponentially.

Another problem with the use of VPNs is that they permit the transfer of data only to those sites that are part of the VPN. If a first customer who has a VPN on the physical network wishes to communicate with another customer who has another VPN on the same physical network, then the first customer has to use an external communications system, for example a public utility telephone system. This results in additional costs and complexity for the customer.

Companies often built several VPNs to the same sites, one for private data communication, one for voice, and one for video. This was expensive but necessary because the underlying networks used to transport these services were incompatible. The advent of ATM permitted all of these services to transverse over a common infrastructure. Unfortunately, ATM was not widely deployed, was expensive, and needed to use the overlay model to accomplish its task. IP became the technology to converge all of these services onto a common infrastructure. IP was already widely used for data communications. H.323, an ITU-T standard, allowed video to ride an IP infrastructure, while Voice Over IP (VoIP) did the same for voice. This greatly reduced the costs of building VPNs for these services because a common infrastructure could be shared. However, the problem still remained that while internal communications within the company could take place over the VPN, communications with other companies, such as vendors or customers, had to take place over a different system.

### SUMMARY OF THE INVENTION

There remains a need to improve the flexibility of networks so that customers are provided with privacy for transferring private data among its own different sites, while at the same time permitting the users to communicate freely with other users on the network, whether or not they belong to the same customer, and also others who are off the network.

Generally, the present invention relates to a communications network on which one or more shared services, such as voice or video, are provided to customers over a respective virtual private network (VPN). At the same time, each customer may have its own private data VPN for handling private company data. The shared service VPN permits users from different customers to communicate directly over the shared service VPN. Trust and security are established at the edge of the network, as the information enters from the customer's site. As a result, no additional security measures are required within the shared service VPN for the communications between users. This architecture results in a fast, high quality shared service.

One embodiment of the invention is directed to a method of providing a communications system to a plurality of customers. The method includes providing, on a communications network, at least one shared service virtual private network (VPN) accessible by a first set of customers for a shared service, permitting communication between users of different customers subscribed to that service. The method also includes providing, on the communications network, at least one private data VPN for handling private customer information, the at least one private data VPN being associated with a respective customer.

Another embodiment of the invention is directed to a communications system for providing communications services to a plurality of customers. The system includes a communications network configured with at least one shared service virtual private network (VPN). A least a first set of customers is connected respectively to the at least one shared service VPN for sharing a respective service on the at least one shared service VPN. The network is also configured with at least one private data VPN for handling private customer information, the at least one private data VPN being associated with a respective customer.

Another embodiment of the invention is directed to a system for providing centralized services to customers on a converged service network. The system comprises a communications network configured with at least one shared service virtual private network (VPN) accessible by multiple customers to receive a service in a shared environment on the converged service network. There is also a central services VPN. Common service units are connected to the central services VPN. The central services VPN is connected to the at least one shared service VPN via at least one security device.

Another embodiment of the invention is directed to a method for providing centralized services to customers on a converged service, communications network. The method comprises providing at least one shared virtual private network (VPN) accessible by multiple customers to receive a service in a shared environment on the converged service network and providing a central services VPN. Common service units are connected to the central services VPN. The central services VPN is connected to the at least one shared service VPN via at least one security device.

Another embodiment of the invention is directed to a system for connecting a customer to a communications network. The system comprises a customer edge (CE) router, a provider edge (PE) router, and a connection between the CE router and the PE router. The CE router is configured to select a VPN over which an IP packet received from the customer is to travel. The CE router selects from i) at least one shared service virtual private network (VPN) connected to the PE router and configured for providing a shared service to multiple customers on the communications network and ii) a private data VPN (PD-VPN) connected to the PE router.

Another embodiment of the invention is directed to a method of connecting a customer to a communications network having at least one shared service virtual private network (VPN) for providing a shared service to multiple customers and a private data VPN (PD-VPN). The method comprises selecting a VPN from i) at least the one shared service virtual private network (VPN) connected to a PE router and configured for providing a shared service to multiple customers on the communications network and ii) a private data VPN (PD-VPN) connected to the PE router. IP traffic is then directed to the selected VPN.

Another embodiment of the invention is directed to a method of directing IP traffic from a customer onto a communications network configured with at least one shared service virtual private network (VPN) and at least one private data VPN (PD-VPN). The method comprises determining which VPN the IP traffic is to be directed to from i) the at least the one shared service VPN and ii) a private data VPN (PD-VPN). Quality of service (QoS) rules are applied to the IP traffic based on the determined VPN.

Another embodiment of the invention is directed to a communications system providing converged IP services to customers. The system comprises a communications network configured with at least one shared service virtual private network (VPN) for providing a shared service a first set of the customers and at least one private data VPN (PD-VPN) for carrying private data of at least one respective customer. The network includes at least one customer edge (CE) router configured to determine which VPN, from i) the at least the one shared service VPN and ii) a private data VPN (PD-VPN), IP traffic received from an associated customer is to be directed to. The CE router is further configured to apply quality of service (QoS) rules to the IP traffic based on the determined VPN.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically presents a configuration of a prior art network;

FIG. 2 schematically presents a configuration of a prior art virtual private network;

FIG. 3 schematically shows labeling of an IP packet;

FIG. 4 schematically shows an embodiment of the physical layer of a converged IP services network according to principles of the present invention;

FIG. 5 schematically shows an embodiment of the logical layer of a converged IP services network according to principles of the present invention;

FIG. 6 schematically shows an embodiment of the customer edge of a converged IP services network according to principles of the present invention;

FIG. 7 schematically shows another embodiment of the customer edge of a converged IP services network according to principles of the present invention;

FIG. 8 schematically shows an embodiment of network logic for providing centralized services to customers on the converged IP services network, according to principles of the present invention; and

FIG. 9 presents steps in an embodiment of a method of labeling IP packets according to an embodiment of the present invention.

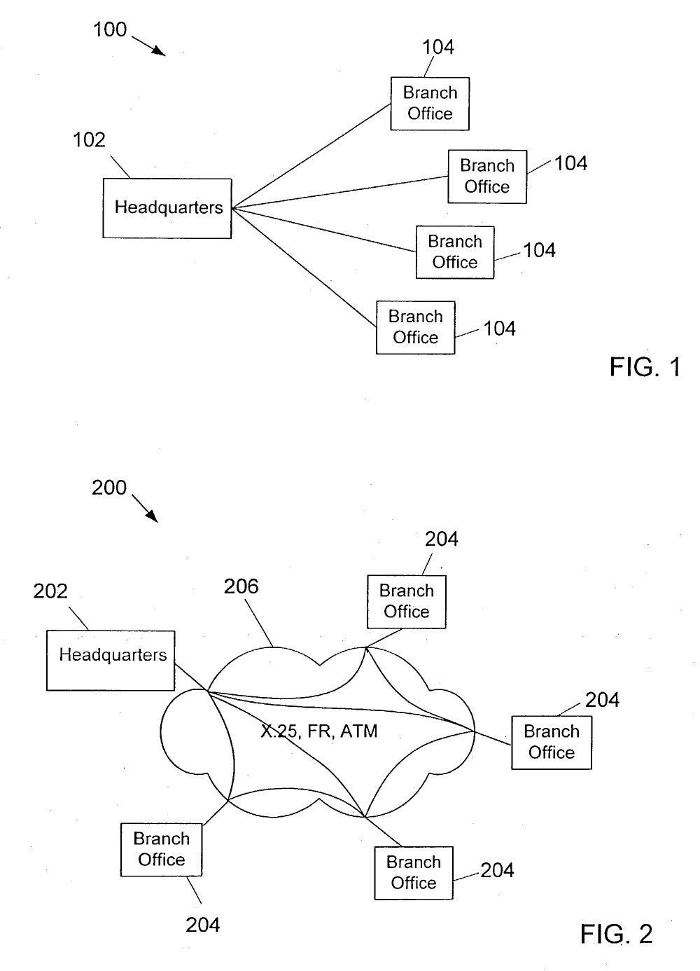

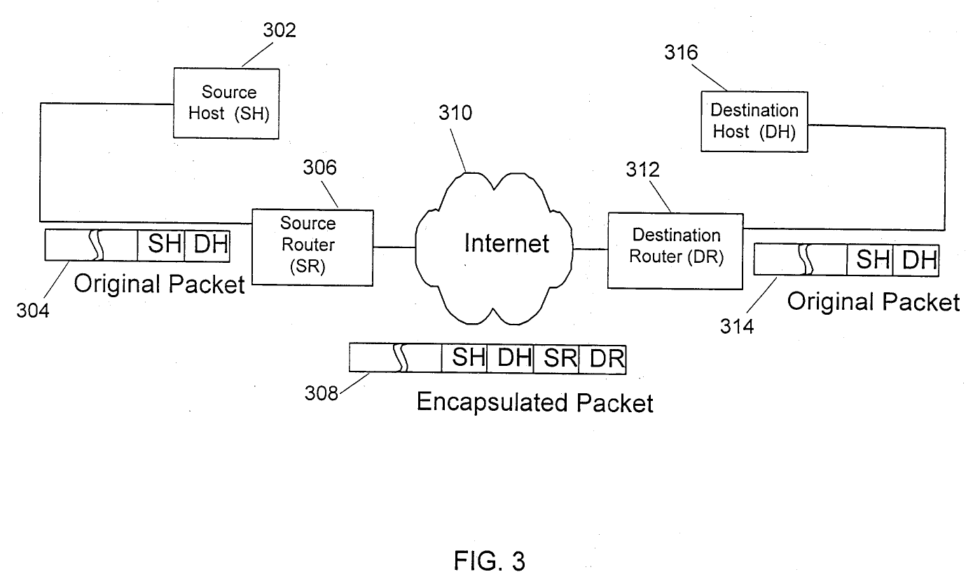

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to a communications network that a service provider supplies to customers for voice, video, private data and Internet services. All the services are provided on the same physical network, which is referred to as a converged network. The service provider is able to offer a fully managed service that includes providing the managed access link (via resale), the access equipment (the customer premises router), management of the equipment and administration of the Internet protocol (IP)-based virtual private network (VPN) services, referred to as the converged IP services.

Overview

To support the IP-based services, the converged IP services (CISP) network approach is to create a layered architecture where the IP routed architecture is built. The IP equipment and the IP backbone may be overlaid on an existing optical or electrical network architecture, which is the framework for offering services. Access service to the IP transport and routed backbone network is made continuous through the local provider's network and over the last mile local loop to the customer end-sites. The service allows customers to acquire access to a site for the aggregation of all traffic. Customers can fully mesh each geographically dispersed site into the VPN-based offering. The service provider may manage the customer edge router, located at the customer premises, that gives access to the high-bandwidth at the edge of the backbone network, and so the service may be configured for end-to-end quality of service (QoS).

The edge of the network provides class of service (CoS) as a way of denoting the relative importance of the customer's traffic contained in the information being transmitted. Classifying and transporting the classified traffic, which are engineered to consume network resources and relates to the price structure of the offered services, are some of the important business decisions associated with overall QoS. QoS techniques enable the service provider to manage different kinds of traffic based on priority and service level agreements (SLAs). The service provider may provide value and SLAs to its connected customer sites by delivering its VPN-based services over its IP network and not over the public Internet. Gateway access to the global Internet and to the public switched telephone network (PSTN) may be accommodated through the service provider's PoPs.

An important feature of the converged IP network is the construction of various VPNs. Another approach for building VPNs, not discussed earlier, is the Peer Model. In a Peer Model, the router with which the customer communicates, known as the customer edge (CE) router, exchanges information with the provider's edge (PE) router, thus allowing the service provider to determine the route to the destination sites. This greatly reduces the complexity of the customer's network. Multiple protocol label switching (MPLS) allows the use of a MPLS-VPN. This is an example of peer model method of building VPNs.

A new approach to providing converged communication services is now described. The IP-based convergent network is based on a quality of service (QoS) architecture that allows the delivery of private network services to customers over a shared service VPN infrastructure. The edge of the network is the location where QoS functionality is defined. QoS is enforced throughout the network. The QoS solution is extended across the edge, the extended edge and the backbone networks.

The QoS techniques include using raw bandwidth and multi-protocol label switching (MPLS) in the backbone network. The extended edge, connecting between the customer and the CE router, uses virtual LANs (VLANs) for logical partitioning of the Ethernet network. In the edge network, frame relay encapsulation allows the creation of virtual interfaces that can be placed into virtual forwarding and routing (VRF) tables. QoS policy can also be applied to the virtual interfaces.

In one embodiment, customer traffic reaches the router in the PoP via a frame-relay-enabled permanent virtual circuit (PVC) configured over a leased-line link. The PVC is a logical connection giving the impression of a dedicated and fixed or point-to-point link. A logical PVC is configured within the access link for every subscribed service from the CE router to the connecting PE router. The traffic is classified through differentiated services before being sent down the PVC.

Once the classified traffic has reached the point of presence (PoP) server, more specifically the edge router, the traffic enters the IP network cloud, where the customer's traffic shares the IP backbone network bandwidth with all other communicating customer sites. All of the customer sites in a community of interest communicate with one another directly through the any-to-any connectivity nature of the IP-based transport network.

IP-based transport means the source and destination devices are defined and identified by logical IP addresses. The IP addressing scheme is integral to routing and forwarding customer traffic through the network. The convergent network accommodates the use of addressing from both the global address space and from the private address space, including customer private addresses.

Customers using their own private addressing schemes are able to utilize the convergent network. The service provider may convert the private addresses to unique addresses for use on the IP converged network when an overlap of private addresses occurs. Private addresses are not visible or directly accessible outside of the converged network.

In the converged backbone network, multi-protocol label switching (MPLS) labels establish the class of service, based on the service classification done at the edge, VPN membership, and the route the packet will take based on the routing protocols. In one example, the OSPF (open shortest path first) and BGP (border gateway protocol) routing protocols may be used Within the network to support the routing policies and the MPLS forwarding mechanisms.

The MPLS packet-forwarding technology used across the backbone network creates the shared service VPNs for the aggregation of each service subscribed to by the customers. MPLS is used as a fast-transport forwarding and switching mechanism to move prioritized IP traffic through the backbone of the convergent network between the customer sites and the services network.

The services network is connected to the backbone network via, for example an extended edge Ethernet network that utilizes a VLAN transport technology to support the private and logical partitioning of aggregated services. VLANs over Ethernet networks are analogous to the VPNs on the IP-routed backbone network and provide an aggregated path for each offered service configured on the network.

Each service or VPN on the overall managed network is utilized for aggregating a multiple number of customer sites. Each service aggregate (each VPN for each service) is proactively monitored for performance to meet the service level agreements (SLAs). The SLA monitoring capability may be provided using a router-based network assurance software tool. The-tool utilizes the management network, which allows network QoS metrics to flow to a performance measuring tool.

Physical Layer

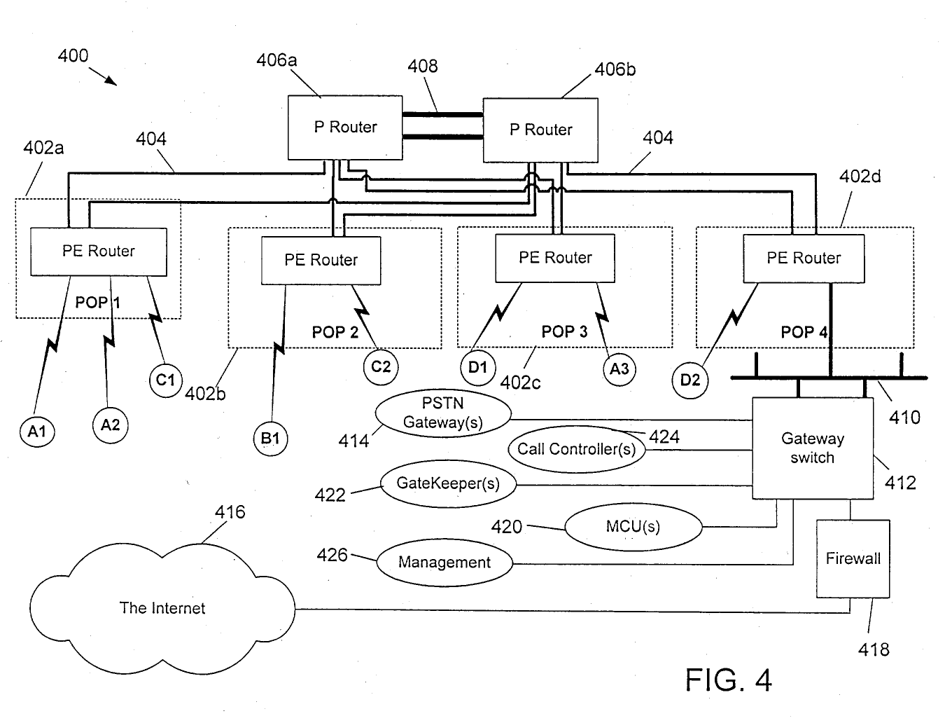

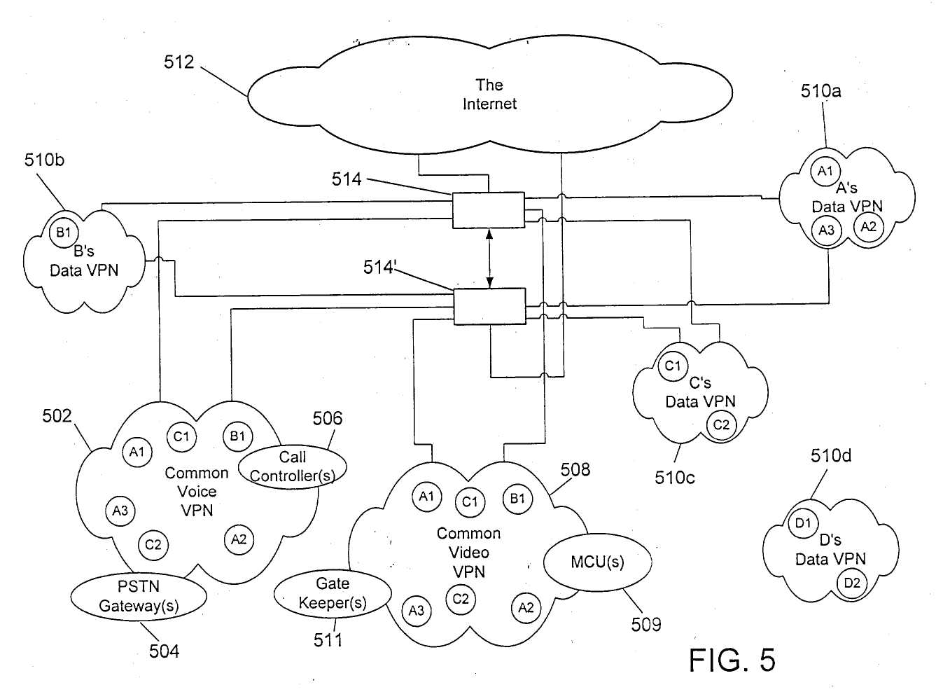

One particular embodiment of the CISP network is now described with reference to FIGS. 4 and 5. For the purposes of illustration only, the network is described as having four customers, A, B, C and D. The customers A, B, C, and D may be different corporate entities. Customer A has three sites at different physical locations, A1, A2 and A3. Customer B has one site, B1. Customer C has two sites, C1 and C2. Reference is first made to FIG. 4, which schematically shows physical connectivity in one particular embodiment of a converged network.

Several point-of-presence (POP) servers 402a, 402b, 402c and 402d, also referred to as provider edge (PE) routers, are connected via high speed uplinks 404, such as OC12 lines, to two or more gigabit switched routers (GSRS) 406a and 406b, referred to as provider (P) routers. In one particular example, the P routers 406a and 406b may be Cisco 12410 Gigabit Switch routers, or equivalent, and the PE routers 402a-402d may be Cisco 10008 Edge Services Routers, or equivalent. The P routers 406a and 406b may be connected via high speed lines 408, for example OC48 lines. The lines 408 connecting between the P routers 406 are generally of a higher speed than the uplinks 404 connecting between the PE routers 402a-402d and the P routers 406, although this is not a necessary condition. The PE routers 402a-402d and the P routers 406a and 406b form the backbone of the IP converged network. The PE routers 402a-402d may be connected to P routers 406a and 406b with redundant connections. The PE routers 402a-402d are multifunctional and provide edge functionality.

The bandwidth capacities on the dual router-up-links 404 may be provisioned so that no more than 50% of the rated line speed is committed, insuring a necessary degree of reliability. This allows for failover of one of the circuits to the alternate circuit without causing a circuit-overload condition. The uplinks 404 to the P routers 406 may be based on SONET (Synchronous Optical Network) technology.

One commonly used protocol for layer-3 IP transport is layer-1 SONET, namely packet-over-SONET (POS). POS modules (or interface cards) on the routers for the uplinks 404 may allow connectivity to an embedded optical network. SONET ADMs (add-drop multipliers) and dark fiber strands provide the efficient transport and the high-bandwidth capacity for IP transport. Routers equipped with POS interfaces map the IP packets into the SONET payload envelope (IP over PPP over SONET). Implementing IP transport directly over fiber entails using SONET framing but may avoid the need for expensive SONET ADM.

The different customer sites are connected to the network through the PE routers. In the illustrated embodiment, sites A1, A2 and C1 are connected via PE router 402a, sites B1 and C2 are connected via PE router 402b, sites D1 and A3 are connected via PE router 402c and site D2 is connected via PE router 402d. Access to the PE routers may be by any suitable method, for example via a private line such as DS1, DS3, and the like, or wireless if the wireless network supports the same Quality of Service (QoS) as used by the network 400. Link layer technologies such as Frame Relay and ATM may be used as an access method to access the network, as is discussed below.

At least one of the PE routers, in the illustrated case PE router 402d, is connected via an extended edge network 410 to a services network 411 that provides for various access functions. The extended edge network 410 connects the services network 411 to the IP backbone network. The extended edge network 410 may be an Ethernet network or subnet The extended network 410 connects to one or more Ethernet switches 412 which aggregates traffic from numerous ports and places it on the appropriate VLAN by configuration. The PE router 402d switches traffic between VLANs based on static or dynamic routing information.

The Ethernet network, commonly referred to as a local area network (LAN), is created to extend the edge network in support of virtual LANs (VLANs). The Ethernet network supports connectivity to the services network, a security device, and the out-of-band management network.

In the illustrated embodiment, the service network is coupled to the extended edge network 410 via a gateway switch 412, such as a Cisco 65XX switch. The gateway switch 412 may be connected to various external services on the service network 411, for example a public switched telephone network (PSTN) gateway 414 and/or the Internet 416. The gateway switch 412 may be connected to the Internet 416 through a managed security device 418. The security device 418 may be a firewall, a proxy device, a security gateway that uses, for example IPSec (IP Security) architecture, an intrusion detection device or a content filtering device or any other suitable unit that provides protection. A firewall typically only allows the passage of traffic based on established policies. The policies may be based on protocol, source address, destination address, direction of traffic, and the like. A proxy device interacts with the traffic stream at the application layer, and is application specific. For example, an HTTP (hypertext transfer protocol) proxy server would terminate an HTTP session, evaluate its appropriateness based on a configured policy and then, if the policy checks were positive, initiate an HTTP session based on the original request. Security gateways are known from the IPSec standard. Intrusion detection devices monitor traffic for defined traffic patterns that may be an indication that someone is trying to attack the network.

In this particular embodiment, the security device 418 is part of the extended edge network 410 and is suspended from the Ethernet switches. Redundant security devices may be deployed since the security device 418 can be a single-point-of-failure. In the event of a failure or outage, the secondary or redundant security device may come on-line transparently and automatically without loss in the active VLAN and security device sessions.

The gateway switch 412 may also be connected to, for example, one or more multipoint control units (MCUs) 420 that provide control for multiple site video conferencing. The gateway switch 412 may also be connected to one or more video service gatekeepers 422 and one or more call controllers 424. The gatekeepers 422 may be used to provide administrative services, for example recording the duration of video calls and which video units were involved in the calls. The gatekeepers 422 may also provide registration services so that any one particular video device knows how to connect with another video device, and admission control services to control how many simultaneous video calls can be made from one site. When first connected to the network, a video unit may register automatically with the gatekeeper 422 or may be registered manually. Call controllers 424 provide intelligence for the Voice IP devices, for example routing phone calls, and provide various voice services, such as call forwarding voice mail, conference calling, and the like.

One or more management devices 426, for example element management systems (EMS), may also be connected to the gateway switch 412. The management devices 426 may be used for managing the P routers 406, and the PE routers 402. Managing the P routers 406 and PE routers 402 may include, inter alia, configuring the routers, maintaining the routers, administering the routers, fault and performance monitoring and/or debugging the routers. The management devices 426 may also be used for managing the CE routers connected to the various PE routers, as is described below.

Logical Layer

A logical view of the network is schematically presented in FIG. 5. The network 400 supports several different types of service, including voice, video, private data and Internet access. In the example using customers A, B, C, and D, different customers are assumed to use different services, as shown in Table I.

TABLE I
Example Service Selection

| Customer | Services Selected |
|---|---|
| A | Voice, Video, Private Data, Internet |
| B | Voice, Video, Private Data, Internet |
| C | Voice, Video, Private Data, Internet |
| D | Private Data |

The voice service provides the customer with voice access to everyone else on the network who subscribes to the voice service. It will be appreciated that not all customers on the network need subscribe to the voice service, and that the voice service is provided to a set of customers. Likewise, the video and private data services may each be provided to different sets of customers, since not all customers need subscribe to the video and private data services.

The voice service is provided by creating a common voice VPN 502 that is shared by multiple customers. A customer is defined as an entity, for example a corporate entity, that uses the network. A user is an individual who uses services on the network. A user may be an employee or agent of a customer. A customer may also be an individual.

A's sites, B's sites and C's sites are connected to the voice VPN 502. Customers A, B, and C can, therefore each communicate by voice among their sites on the network, without going through a PSTN or a security device. For example, a user at one of A's sites can contact another user at one of B's sites over the voice VPN 502, without going off-network via a PSTN, or going through a security device. This improves the quality of the voice service and may also reduce costs by avoiding long distance charges. Furthermore, voice calls between locations on the voice VPN 502, irrespective of whether they are calls within a single customer or between customers, do not pass through a security device once on the voice VPN. As a result, the delays in transmitting voice traffic are reduced and so the quality of voice communications is high. The voice VPN 502 is connected, for example through a central services network as is described below, to the PSTN gateway 504 so that voice communications can be made from the customers having the voice service to others who are not on the network. One or more call controllers 506 may be connected, for example via a central services network to the voice VPN 502. The call controllers 506 are used for controlling the voice communication system, as is explained elsewhere.

Similarly, the video service is provided by creating a common video network 508 that is shared by multiple customers. Consequently, A's sites, B's sites and C's sites are connected to the video VPN 508. Customers A, B, and C can, therefore each make video conference calls between their own sites on the network, without going through a security device or multi-point control unit (MCU). Furthermore, customers A, B and C can make video calls to each other on the video VPN 508 without going through a security device. Since no security devices are needed, the possibility of delaying video traffic is reduced, and so the quality of the video service is high. The common video VPN 508 is connected to a gateway to permit video conferences to be connected with others who are not on the network. MCUs 509 may be connected, for example via the central services network, to the video VPN 508, for controlling video conferences, for example to control video conferences involving more than two locations. In addition, one or more MCUs may provide a gateway to non-lP (legacy) video devices. One or more gatekeepers 511 may also be connected to the video VPN 508 via the central services VPN.

Customers may have their own private data VPN (PD-VPN) that protects the private data from outside entities. For example, A, B, C, and D are each associated with its own PD-VPN 510a, 510b, 510c and 510d. Different PD-VPNs may have different levels of external accessibility, managed through the security device 514. For example, D's PD-VPN 510d is isolated, and has no access from others, either on the network or via the Internet 512. A's PD-VPN 510, on the other hand is connected to the managed security device 514. The managed security device 514 may be used to impose rules for the transfer of data to and from the Internet or between PD-VPNs. For example, the managed security device 514 may impose rules for the transfer of data from A's PD-VPN 510a to B's PD-VPN 510b. One example where such access might be useful is where B is a customer of A and an agreement between A and B permits B to view inventory of stock. C's PD-VPN 510c may or may not be accessible to A or B, and may or may not be accessible to the Internet 512 via the managed security device 514. The managed security device 514 may also permit the passage of voice and video traffic between Internet and the voice and video VPNs 502 and 508.

The security device 514, which may operate with a backup security device 514′, is logically connected to each shared VPN. Security device rules may be added to the unique partitions of the managed security device 514 for each VPN. For example, such rules permit the restricted transfer of data to or from another VPN or the Internet. In illustration, one such rule may allow access to A's corporate Web site from the Internet.

Provider/Customer Interface

An important feature of the present invention is the interface between the customer site and the CISP network. This interface is formed between two routers, namely the customer edge (CE) router and the PE router. The CE router may be owned and administered by the service provider, even though the CE router is located at the customer's site: this increases system security. The CE router is the point where services are identified and handling instructions are made to match a quality of service the customer is requesting. The CE router faces the users on the customer site and may connect to the customer's subnet and application devices. The CE router provides the functionality needed to access the CIPS network. The CE router connects in a point-to-point fashion to the edge network via the PE router.

Physical connections between the CE router and the PE routers may be made using local high speed links, such as DS-1, DS-3 lines, and the like, split into multiple logical interfaces. Other types of connection may be made via, for example, DSL, cable modem or wireless. These software-configurable interfaces or sub-interfaces may be derived from a frame-relay data link control identifier (DLCI). The DLCI is defined as a number in the frame relay address field. The DLCI may be considered to be a point-to-point and fixed or permanent virtual circuit (PVC). The logical PVC channel maintains a permanent association or connection between the CE and PE routers.

The connected customer subnets may use the backbone network as an extension of their wide area networks (WANs) for communication and connectivity. The CE router is attached to the PE router and interfaces to the convergent network at layers 1, 2 and 3 as characterized by the OSI reference model.

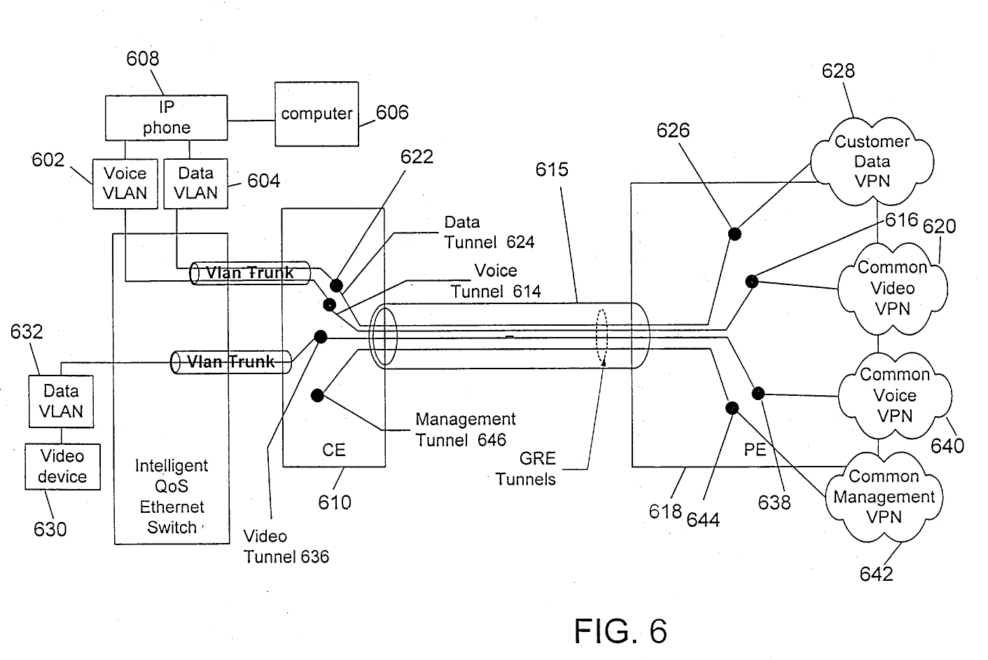

One particular embodiment of the interface between the customer and the network is schematically illustrated in FIG. 6. This particular embodiment is directed to the use of generic routing encapsulation (GRE) tunnels over point-to-point protocol/multi-link point-to-point protocol (PPP/ML-PPP).

The customer has a voice virtual local area network 602 (VLAN) and a data VLAN 604. Both the voice VLAN 602 and the data VLAN 604 use the Internet protocol (IP). The customer's voice network may use IP telephones, using Voice over IP (VoIP) or may use conventional telephones run through IP adapters. Where IP telephones are employed, a common architecture is to couple an individual's computer 606 to the data VLAN 604 via the IP telephone 608, which is hooked up to an Ethernet network. Voice traffic may be placed onto an auxiliary IEEE 802.1Q VLAN by the IP telephone 608. The voice traffic arrives at the CE router 610 on an Ethernet logical interface 612 assigned to the voice VLAN. The CE router may be for example, a CISCO 2651 router or a Cisco 1760 router.

A policy-based routing (PBR) rule applied to the Ethernet logical interface 612 directs the traffic down the GRE tunnel 614 used for voice. The tunnel 614 passes through a connection 615, for example a local access connection, to the PE router 618. The local access connection may be any suitable transport for the traffic between the CE router 610 and the PE router 618. For example, the local access connection may be a DS-1 line, a bonded DS-1 line, a DS-3 line, a bonded DS-3 line, another DS-N line, a digital subscriber loop (DSL), an OC-N line, an Ethernet connection, a dial-up Frame Relay, and ISDN line, a wireless connection and the like.

The other end of the tunnel 614 is terminated on a tunnel interface 616 in the PE router 618. The tunnel interface 616 has been placed in the virtual routing and forwarding (VRF) for the common voice VPN 620. The customer's voice traffic, therefore, enters the common voice VPN 620.

It will be appreciated that only IP traffic that has been addressed to locations outside the local VLAN is directed down the GRE tunnels.

Private data are handled in a very similar manner to voice traffic. Private data may be placed onto the data IEEE 802.1Q VLAN by the IP telephone 608. The data traffic arrives at the CE router 610 on an Ethernet logical interface 622 assigned to the data VLAN. A PBR rule applied to the logical interface 622 directs the traffic down the GRE tunnel 624 used for private data. The tunnel 624 passes through the connection 615 and is terminated on a tunnel interface 626 in the PE router 618. The tunnel interface 626 has been placed in the VRF for the customer's private data VPN 628. The customer's data traffic, therefore, is maintained separate from the voice traffic, and enters the customer's data VPN 628.

Video data are also handled in a similar manner. Video equipment 630 is connected, via static or dynamic configuration, to a data VLAN 632, that is connected, via an Ethernet link 634 to a video tunnel 636 in the CE router 610. The video data pass through the connection 615 to the PE router 618. A video tunnel interface 638 in the PE router 618 has been placed in the VRF for the common video VPN 640, and so the video data enters the common video VPN 640.

Various management functions, for example for controlling the CE router 610, may be carried out by connecting a common management VPN 642 to a management interface 644 that is connected via a management tunnel 646 to the CE router 610. The CE router 610 may be managed by the one or more management devices 426 via the common management VPN 642. Management functions performed over the common management VPN 648 may include, but are not limited to, configuring, maintaining, administering, fault and performance monitoring and/or debugging. The common management VPN 642 terminates within the CE router 610 and is not accessible by the customer. The use of a common management VPN 642 provides additional security compared to other management techniques, such as router management through the Internet.

Another approach to connecting the correct traffic to the appropriate VPN is using-Frame Relay data link control identifiers (DLCIs), for example permanent virtual circuits (PVCs). The DLCI is defined as a number in the frame relay address field. The DLCI is considered a point-to-point and fixed or permanent virtual circuit (PVC). The logical PVC channel maintains a permanent association or connection between the CE and PE routers.

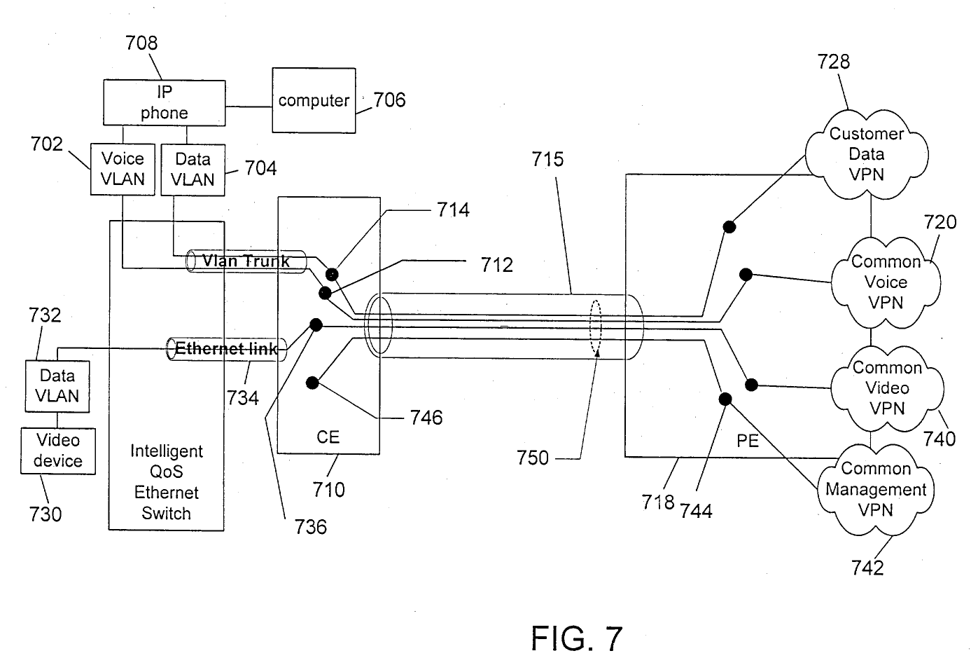

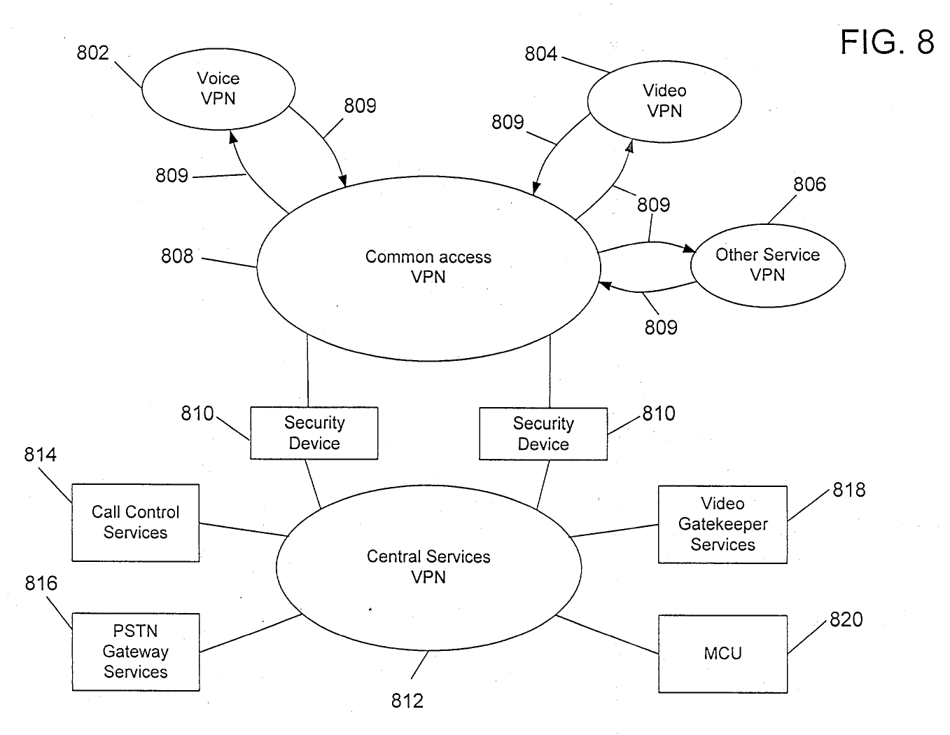

This is now explained with reference to FIG. 7. As in the embodiment described with reference to FIG. 6, a voice VLAN 702 carries voice traffic from telephones 708, for example IP telephones or IP adapted telephones, and a data VLAN 704 carries data traffic from various individuals' computers 706. The computers 706 may be any suitable type of computer, including personal computers, laptop computers, workstations, servers or the like. The computers 706 may be networked with the telephones 708.

At the CE router 710, Ethernet logical interfaces 734 are assigned to the appropriate VLAN. The voice logical interface 712 is assigned to the voice VLAN 702 and the data logical interface 714 is assigned to the data VLAN 704. Various PBRs may be used to direct the voice and data traffic along the connection 715 to the PE router 718. The connection 715 may be a local access connection. In this particular embodiment, the local access connection is suitable for carrying Frame Relay. Various DLCIs 750 are defined through the connection 715, associated with the different types of data to be carried between the CE router 710 and the PE router 718.

At the PE router 718, the appropriate DLCI 750 is assigned to the appropriate VRF and thus the correct VPN. The voice DLCI 750, connected to the voice logical interface 712 in the CE router 710, is connected via the voice VRF to the common voice VPN 720. Thus, voice traffic from the voice VLAN is transmitted into the voice VPN 720. Likewise, data traffic from the data VLAN 704 is connected through a DLCI 750 to the private data VPN 728 via the data VRF.

Video equipment 730 is connected to a video data VLAN 732, that is connected, via an Ethernet link 734 to a video logical interface 736 in the CE router 710. The video data pass through the connection 715 to the PE router 718, to the common video VPN 740.

Multi-VRF may be used on the CE router 710. Multi-VRF is a scaled down version of a multi-protocol label switched (MPLS) VPN. The interfaces in the CE router 710 may be configured as a member of a local VRF. Members of the same VRF can exchange packets with each other. A separate routing table is created with each new VRF. Traffic is not exchanged between two local VRFs unless specifically configured to do so: this naturally separates the traffic into secure domains. For example, the voice VLAN Ethernet logical interface 712 is assigned to the voice VRF on the CE router 710. The CE Frame Relay logical interface (DLCI) that connected to the voice VRF on the PE router 718 may be assigned to the voice VRF on the CE router 710. Likewise, the DLCI connected to the video VRF on the PE router 718 may be assigned to the video VRF on the CE router 710. In addition, the data logical interfaces 714 may be placed into the customer's private data VRF. The data, video and voice traffic remains separate because each VRF is unaware of the interfaces or the IP addresses of the other VRFs.

Some type of security policy may be executed at the CE router to reduce the possibility of a hacker attacking the network or that the wrong type of traffic is directed to the VPN. For example, an access control list (ACL) may be added to each interface that enters or exits the CE router 710. On the voice VRF interfaces, the ACL restricts traffic to those protocols used for VoIP communications. On the video interfaces, the ACL restricts traffic to those protocols used for video communications.

The functionality of the customer edge interface is now described. The logical PVC is a subset of the access link 715, DS-1, DS-3, or whatever is used. The PVC rides over the access link 715. IP traffic flows through the frame-relay-enabled PVC connection and is known as frame relay encapsulation. The PVC is defined in advance of any traffic routing. A DLCI/PVC functions bi-directionally and provides traffic in both directions—CE router 710 to PE router 718 and PE router 718 to CE router 710—and is used for network/service management and the transport of each subscribed service—voice, video and Internet/private data network.

From the perspective of the customer subnet (the VLAN side) connecting to the CE router, the CISP network learns the layer-2 data link MAC address of the CE router's Ethernet interface or interfaces. The Ethernet interface is the customer-facing link that is used to connect to the customer subnet-customer's specific equipment, such as video device, and to the customer's local area network (LAN).

A peering relationship is established between the CISP network and the customer subnet. The relationship is established for the exchange of route advertisements or aggregated routing information and the transport of traffic across a direct and private link connecting the CE and PE routers 710 and 718.

The service provider establishes the private connection using logical interfaces (DLCIs/PVCs), which are configured over the access link 715 connecting the CE and PE routers 715. Each logical interface or port on either end of the DLCI/PVC has a unique identifier. An IP address on both the PE port and the CE port is unique to the CISP network. Once a port is configured between the CE and PE routers 710 and 718, routing information between the two routers is exchanged.

The exchange of route information may be established at the peering point based on static routing or a dynamic routing protocol such as External Border Gateway Path (EBGP). Static routing may be employed when a dedicated connection 715 links to the CISP network and the customer does not have a routed network behind the CE router 710. Otherwise, EBGP may be used as the routing protocol.

The CE router 710 is able to do routing and forwarding based on IP addresses. The CE router 710 is said to peer or advertise its addressable routes, via static routing or dynamic routing, with its directly connected PE router 718. The CE router 710 need not peer with other CE routers, since the PE router 718 learns the routes that lead to other CE sites.

Ranges of IP address blocks may be aggregated into reachable routes. Traffic routing to the site is reachable through a route that is advertised by the site's connected CE router 710 to the PE router 718. The routing table in the CE router 710 relates the destination IP address to the DLCI/PVC. The IP packet is unpacked from the PVC at the PE router 718, an IP lookup is completed, and the IP packet is dynamically assigned to an appropriate forward equivalence class (FEC) and label switched path (LSP) for transport across the CISP network.

The CE and. PE routers 710 and 718 maintain a constant connection with the DLCI/PVC in order to transfer routing information between the customer's network and the CISP network.

Various management functions, for example for controlling the CE router 710, may be carried out by connecting a common management VPN 742 to a management interface 744 that is connected via a management DLCI 746 to the CE router 710. Management functions have been described above with respect to FIG. 6. There may be no logical interface in the CE router 710 through which the customer can connect to the common management VPN 742, so the customer may be prevented from accessing the common management VPN 742.

The use of a connection 715 having multiple point-to-point logical interfaces allows the segmented flow of customer traffic into separate VRF tables, based on traffic type and the subscribed VPN service. Each PE router 718 has a number of VRF tables associated with the specific convergent service as well as a global routing table to reach sites on the global, public Internet. Any customer belonging to a specific VPN is only provided access to the routes contained within the associated table. In other words, a VRF table is associated with each and every configured DLCI/PVC. Each DLCI/PVC channel relates to and supports a specific VPN service or function, namely voice, video, private data network (PDN) and Internet combined and management. A fifth routing table, for global Internet routing, may also be present.

Central Services Architecture

The service provider provides many services to the customers. Examples of services for voice include call control features such as call waiting, call forwarding, conference calling, voice mail and the like. Examples of services for video include, for example video bridging. A common feature of such services is that they are a common resource, available to all who subscribe to the community VPNs. Accordingly, it is common to centralize these services in one or more portions of the network and to allow access from subscriber customers. Since these services may be critical to the function of products sold by the service provider to the customers, it is important to provide protection from malicious or unintentional attacks. Some other approaches to providing central services allows the customers direct access to the services, which leaves the services open to such types of attack as intrusions or denial of service.

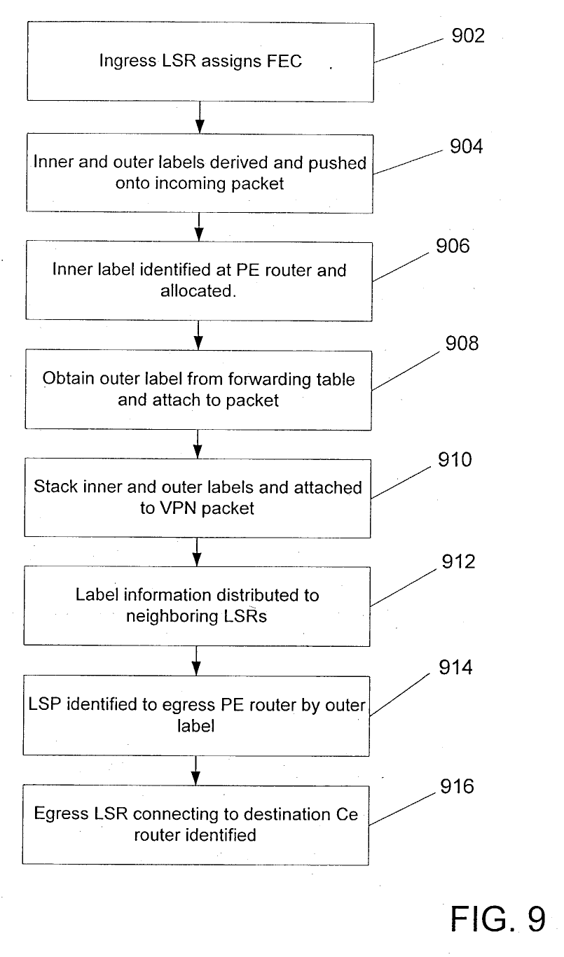

One particular approach to providing central services, while at the same time maintaining a high level of service security and system efficiency, is now described, with reference to FIG. 8. As has been discussed above, customers who subscribe to the voice service are made members of the voice VPN 802 and customers subscribing to the video services are made members of the video VPN 804. Other common services offered by the service provider, to which customers may subscribe, also be provided by making the subscribing customers members of other VPNs 806.

The shared service VPNs, also referred to as communal VPNs, such as the voice VPN 802, the video VPN 804 and the other service VPNs 806, are connected to common access VPN 808 that provides access to the central services. The service VPNs 802, 804, 806 are connected to the common access VPN 808 via import and exporting route targets 809 connecting between the individual service VPN 802, 804 and 806, and the common access VPN 808. The common access VPN 808 may have the characteristic that it cannot be used to transport traffic between connected service VPNs 802, 804 and 806. Consequently, for example, a user on the voice VPN 802 is not able to hack into video traffic on the video VPN 804. As a result, the common access VPN 808 may sometimes be referred to as a DMZ VPN.

One or more security devices 810 may be connected physically, for example via SONET, DS-3, or the like, or logically, for example via VLAN, PVC, or the like, between the common access VPN 808 and a Central Services VPN 812 to which the central services are connected. The security devices 810 may be, for example, firewalls, proxy devices, security gateways, intrusion detection devices or content filtering devices.

The central services may include, for example, call control services 814 for controlling voice traffic on the voice VPN, PSTN gateway services 816 for providing off-network voice access, video gatekeeper services 818 and/or multiple-point control services 820. The security devices 810 may be operated in parallel (as illustrated) to provide redundancy, and thus reduce inaccessibility of the Central Services VPN 812 in the presence of a security device failure. The security devices 810 may provide firewall services allowing passage only of those packets containing the required protocols and application data to cross them. The security devices 810 may also detect intrusions and block common methods of attack. The security devices may also provide Denial Of Service protection (DOS) which prevents traffic from flooding the Central Services VPN 812 and knocking out a service.

Quality of Service (QoS)

IP-based VPNs are enabled through routing intelligence on either a CE router, known as premise-based IP VPNs, or within the PR router, commonly known as network- or carrier-based IP VPNs. The network-based approach can serve a multiple number of customer sites from a single PE router. The premise-based and network-based solutions are two common approaches for deploying equipment and setting up IP VPNs. The CISP network may use a combination of both the premise-based and network-based IP VPN approaches. The composite solution, referred to as the provider-provisioned VPN solution, enables end-to-end QoS where the CE routers are part of the overall managed network. This combination approach allows the service provider to establish a communications session by tagging priority traffic for preferential treatment over its base IP network where the customer can expect privacy, security and management of its virtual private network.

VPNs enable all real-time interactive traffic and other lower priority services and applications, which are distinguishable on the CISP network. The CISP network provides discernible QoS and traffic management capabilities, based on a combination of protocols to establish the VPN at the edge and in the core. Quality of service is implemented end-to-end in the IP VPN implementation. During momentary periods of congestion, the CISP network advantageously has the ability to mark, queue and forward packets with specified end-to-end QoS requirements. End-to-end QoS is the ability to control bandwidth and packet latency (delay), jitter (delay variation) and loss. QoS deals with the overall traffic management capability of the network and how classified services are delivered when the network gets congested.

Class of service (CoS) is a subset of QoS and refers to traffic delivery priorities. Under CoS, the CISP network may examine the packet headers and determine the class of traffic associated with the subscribed service supporting a given customer application. CoS enables a more predictable level of traffic delivery over the CISP network by assigning different priority levels to the various services and applications. The level may range from higher priority for voice and video services, which require more immediate network response to a lower priority for email and Web surfing applications.

The CE router combines IP CoS markings with core transport technology and provides deterministic bandwidth between the edge network and the edge of the customer's network. Using CoS techniques, customer traffic is assigned a priority and the prioritized traffic is transported end-to-end across the network. Where the service provider owns or manages the CISP network end-to-end, including the CE routers, the service provider can therefore dictate priorities across its managed network.

QoS is associated with network equipment, specifically addressing potential network congestion and bandwidth limitation issues. To address QoS end-to-end across the IP-based network, QoS is broken down into major components to manage network resource allocation during contention in the network.

In one embodiment, the following QoS and CoS components may be part of the CISP network's end-to-end VPN implementation:

1) raw bandwidth, in the backbone network;

2) DLCI/PVC, in the edge network between the CE and PE routers.

3) Class of service—Differentiated Services (Diff-Serv), in the edge network between the CE and PE routers, and where applicable in the customer subnet between the CE router and the application end-device;

4) Class-Based Weighted Fair Queuing (CB-WFQ), on all routers, specifically the CE and PE;

5) VPN-specific routing and forwarding (VRF) tables, in the edge network on the CE and PE routers.

6) MPLS, across the backbone network; and

7) VLANs, across all Ethernet subnets, such as the extended edge network, the services network, the customer networks, and the management network.

These are addressed in turn.

Raw bandwidth: this means over-provisioning the network backbone with adequate bandwidth to support the aggregated traffic load produced by the edge networks. It is difficult and expensive, however, to scale raw bandwidth alone to an amount that will prevent any conflicts for network resources and allow the elimination of other QoS mechanisms. QoS mechanisms are required to ensure that adequate network resources are available to support the VPN across the CISP network.

DLCI/PVC: the maintenance of a private and fixed path between the customer edge site and the CISP edge network uses a permanent logical association between the customer site, the CE router, and the CISP network cloud, the PE router. The use of a PVC enables this. The PVC is used specifically in the access portion of the network for the transport of a VPN in the edge network. A PVC is a separate configurable virtual interface configured on the CE router and the connecting PE router. A PVC supports each subscribed service-voice, video and private data network/Internet.

Class of Service (CoS): Different approaches may be used for providing CoS in an IP network. One approach is called integrated services, and is referred to as Int-Serv. Int-Serv is based on reserving bandwidth for sending data, on a per session basis. Int-Serv uses a signaling protocol called resource reservation protocol (RSVP) to communicate the needs of the traffic that is going to be sent. Each router along the path between the source and the destination sets up its queues to support the flow's reservation and to maintain soft-state. If one of the routers on the path does not have the resources for the flow, it can reject the reservation. Although this method does provide predictable behavior, its does not scale well in a large network such as a service provider network. A service provider network contains hundreds of thousands of flows and its routers have difficulty in maintaining soft-state and individual queuing for such a large number of flows. Future developments on Int-Serv QoS may render it more suitable for service provider networks.

Another approach to providing CoS on the CISP network is called differentiated services, and is referred to as Diff-Serv. This approach is preferred for use on a service provided network because of its ability to scale with size. Diff-Serv is based on reserving bandwidth based on the class of the packet being sent, and defines a six-bit field in the IP header known as the diff-serv code point (DSCP). The three most-significant bits represent the priority of the packet. These three significant bits of the DSCP (the IP precedence bits) are encoded or mapped automatically via software into the MPLS EXP bits to form a total of eight classes of service at the edge and across the backbone of the CISP network.

Diff-Serv also uses a per hop behavior (PHB) definition installed at each queuing point. Although PHB is usually installed manually and is monitored, Diff-Serv is more scalable in a service provider network because packets are queued based on their class of service and not on their destination/source IP addresses.

Diff-Serv is flexible in that a router may be provided with a set of rules so that it may classify or mark a packet based, not just on the type of information in the packet, but also on other characteristics, such as amount of other traffic present at the same time. For example, the service provider may provide the customer with certain guaranteed minimum transfer rates for voice, video and data based on the capacity of the connection between the CE router and the PE router. In illustration, assume that the capacity is 1 Megabits per second (1 Mbps) and that the service provider has guaranteed that the minimum for voice is 300 kilobits per second (kbps), for video is 500 kbps and for data is 100 kbps. The rules may allow the amount of data being transferred to exceed the guaranteed minimum if the volume of video traffic is below its guaranteed minimum, but to cut back the rate of data transfer if the amount of video traffic increases. It will be appreciated that many different types of rules may be used, depending on the types of services the service provider wishes to provide to the customer.

The flows associated with an IP telephone may include voice signaling, the voice data component, for example HTTP (hypertext transfer protocol) data, and the actual voice conversation. Each of these flows is common to the voice VPN, which is configured over the same DLCI/PVC. To differentiate the flows for delivery priorities at the CE and PE routers, explicit CoS attributes, based on diff-serv, may be introduced into the network.

Diff-serv differentiates traffic at the edge—in the CE router, in the PE router and sometimes in the application end device. Diff-serv marks packets with the DSCP so the network can differentiate between levels of service via different queuing priorities. Outgoing framed traffic is sent to one of multiple queues with different priorities. The queues are assigned to the connecting link (the DLCI/PVC) into the network. A transmission queue is created for each service class when a bandwidth amount is allocated to the queue or buffer.

CB:WFQ: Each logical interface on a router has related input and output buffers. Buffers are physical blocks of memory and are important parts of the routers since they affect network performance. Packets are queued up and into the buffers. The queues are collections of packets waiting in the buffers for processing and forwarding across the network. Network traffic or packets of information contend with other traffic at each hop or router (traffic contention is at the buffer) where the arrival times of all the packets at the router and into the queues are not predictable. To offset the contention at the router for the departure from the buffers of these packets to the next hop, QoS queuing mechanisms are engaged on the buffers. The buffers are provisioned to support the service queues associated with the input and output interfaces on the routers.

Queue management schemes address packets entering and leaving the buffers. The queuing technique may be based on the use of multiple queues with different priority levels for the different class of services. The class-based queuing technique works in conjunction with the diff-serv code point (DSCP). Based on the diff-serv-assigned CoS, the different types of IP traffic are placed in different priority queues, a queue for each type of traffic or each CoS.

One approach to fair queuing is class-based weighted fair queuing (CB-WFQ). CB-WFQ places customer traffic in separate queues, according to traffic classification (based on diff-serv) where each traffic queue is granted a portion of the total bandwidth configured on the uplinks in the network. The bandwidth is allocated to the traffic, based on CoS, during congestion.

Interactive voice and video traffic are sensitive to packet loss, delay and jitter. These higher priority traffic types need to be queued and sent over the network first. The real-time queues (voice and video) are serviced with higher priority over the lower-priority queues (email and Internet data), which can afford retransmission if congestion occurs and the buffers in the routers become full and the packets are discarded or dropped.

In other words, the flow of traffic to each buffer is based on the application flow, such as voice, video or Internet.

Virtual forwarding and routing tables (VRFs): VRFs are associated with the CE router and the PE router. A VRF is defined at the CE router and the PE router. The CE router may maintain a VRF table for each subscribed VPN service at the particular customer VPN site. A PE router may maintain a VRF table containing information on each connected VPN customer site as the common voice or video VPNs.

One embodiment of VRF includes:

1) A set of interfaces or sub-interfaces connecting CE and PE routers. Each VRF table is configured to accept the arrival of packets on a particular interface or virtual interface that it supports. The virtual interface is the logical DLCI/PVC or VLAN sub-interface connecting the CE and the PE routers. A DLCI/PVC, interface or VLAN is affiliated with each subscribed VPN service.

2) A VRF defined for each customer VPN site at the CE router and the connected PE router. The PE router maintains the separate VRF tables. The VRF tables control the flow of information into and out of the VPN, thereby creating a private customer network and allowing any-to-any connectivity within the VPN membership.

3) An IP routing table for storing packet forwarding information. This may be a VRF table within the CE router having static routes or a peering EBGP relationship with its connected PE router. This may also be a IBGP routing protocol between PE routers (LSRs). The VRF table within the PE router has an IBGP peering relationship with another PE router for aggregating and forwarding customer VPN traffic across the core.

When IBGP is used, the customer IP address space for a given customer VPN site is unique to the other VPN sites. To support any overlapping IP addressees between communicating customer VPN sites, a route distinguisher (RD) is used to augment the address for uniqueness. The unique packet, the VPN-IP packet, is now prepared for forwarding across the CISP network. The forwarding is accomplished with MPLS.

Multi-protocol label switching: MPLS allows the service provider to engineer the IP network by establishing multiple routes or paths, called label switched paths (LSPs). These unidirectional LSPs are much like virtual circuits where each dynamic path is associated with a network prefix. The diff-serv-marked CoS-packet is associated with an MPLS label, within the PE router, where the labeled packet is then placed in the LSP. Customer traffic flows are assigned to the LSPs according to the requested service or application flow and its associated QoS requirements.

MPLS allows a mapping capability between diff-serv and an MPLS-enabled LSP. The MPLS header has a three-bit experimental (EXP) field in the MPLS label stack that may be used to assign and identify the required number of service classes. The EXP bits are mapped to the three most significant DSCP bits.

The LSP used for information entering the network may be referred to as the ingress LSP, while the LSP used for sending information off-network, to the customer, is referred to as the egress LSP. The ingress LSP, on the PE router, looks at the logical interface on which the packet has arrived and assigns a forward equivalence class (FEC), based on the destination IP address, by the CE router or end device, to the specific flow of packets within the DLCI/PVC and its affiliated VRF table. All packets associated with a flow of common packets are mapped to a FEC and are then assigned a label, referred to as the inner label, which represents the network-based VPN in which multiple customer sites utilize across the backbone network.

The service provider may set up network-defined paths (LSPs) across its backbone network by using the IGP (interior gateway protocol) routing protocols OSPF (open shortest path first) and BGP (boundary gateway protocol) and the signaling protocol LDP (label distribution protocol) for forwarding MPLS-enabled traffic across the network. One embodiment of how MPLS is used across the backbone network is now described, with reference to FIG. 9.

First, at step 902, an FEC is assigned to an incoming packet by the ingress LSR, the PE router. Next, two labels, an outer label and an inner label, are derived from the label-forwarding table, at step 904, and pushed onto an incoming packet at the ingress LSR to define a forwarding path.

The inner label is identified, at step 906, at the PE router to represent the FEC and the service-specific VPN type, e.g. voice, video, etc. The inner label is allocated based on each route (CE to PE) in the VRF table. The corresponding VRF table in the ingress PE router is associated with the destination address of the egress PE router. Between the egress PE and ingress PE routers, LDP propagates the inner label for the ingress PE router. The inner label is associated with the service endpoint, which may be another customer VPN site or a piece of network service equipment, such as the voice gateway.

At step 908, an outer label is obtained from the global forwarding table at the ingress PE router for per hop forwarding across the backbone and attached to the packet already labeled with the inner label. At step 910, the two labels are stacked together and are attached to the VPN packet at the ingress PE router and sent to the egress PE router. The MPLS-enabled LSR has a label-forwarding table and distributes the label information to its adjacent neighbor LSR, at step 912. The label-forwarding path, on the outer label, is based on the global routing/forwarding tables that were built with the traditional routing protocol OSPF. The outer label, at step 914, identifies the LSP to the egress PE router via label swapping across the backbone. Label swapping at each router along the path is distributed by label distribution protocol (LDP). Label distribution or swapping of the outer label is utilized at the LSRs (P routers) as the packet traverses the CISP network. Each time a packet makes a hop to another router the packet gets another new outer label, except at the penultimate (second to last) hop, the outer label is stripped.

The packet's inner label identifies, at step 916, the egress LSR, the PE router and perhaps the interface, connecting to the destination CE router. The inner label is coupled with IBGP, binding the VPN-IP or IP route to the LSP. The inner label is removed and the IP or VPN-IP packet is sent to the PE router's outbound interface to the CE router.

Logical partitioning over the Ethernet subnet, the extended edge network from the PE routers to the Ethernet switches, may be accommodated using virtual local area networks (VLANs). The VLANs are created as logical connections between the physical Ethernet ports on the PE routers and the connecting Ethernet switches. Also, VLANs may be on the centralized security device, the customer subnets (CE router to customer LAN and application end-devices), the out-of-band management network, and the service provider's services network (Ethernet switch to IP service equipment-voice, video, Internet) to logically partition the respective networks in the support of provider-provisioned VPN services.

VLANs may be associated with the IEEE 802.1q specification, which establishes a standard method of creating VLAN membership by inserting a tag (a VLAN ID) into the layer-2 MAC Ethernet frame. The tag includes three bits (specified by IEEE 802.1p) that are reserved for use in the definition of eight different classes of service or delivery priority levels.

Addressing

An IP address identifies a specific router or a specific computer or application end-device, such as an IP telephone, on the subnet of an interconnected network. The IP logical networking scheme (IPv4 addresses) functions at layer-3 as a network overlay for the connected IP network. The IP layer-3 address links directly to the location of the actual physical device. As part of the router configuration process, a network is associated with an interface by assigning the network's unique IP address to the circuit on which the interface is configured. The IP addressing scheme is important for routing packets through the network. The logical IP address has two parts: a network identifier or number and a host identifier or number. The network portion or the front portion of the address (known as the network prefix) defines and identifies the network (or subnet). The host number, or rear portion of the address, identifies the host on the network or subnet. The front and rear portion of the address is not fixed.

The CISP network may use addressing from a private address space, as well as for some services globally-unique addresses. Three blocks of non-registered IP address space may be allocated for use on any private network. From the perspective of the global Internet, private addresses have no global meaning and are not publicly advertised. The addresses are private and unique to the CISP network and to its connected customers' networks. Private addressing allows the service provider operational and administrative convenience as well as giving safe connectivity (via the security device) to the Internet for customers.

The service provider may assign both public and private addresses to the same physical medium or data link subnet. For example, a customer may subscribe to a video-conferencing service, which uses global-unique Internet addresses, and subscribe to an IP voice service using an IP phone, which uses private addresses from the service provider's private address space.

When not using their own private address space, customers may be allocated subsets of the service provider's private address space as required. This sub-allocation of addresses implies that customers with addresses allocated from underneath the service provider's allocations, for routable address purposes, are routed via the service provider's IP infrastructure. This inherently means these connected customer subnets are subscribing to a provider-provisioned VPN solution and are a part of the service provider's managed network service.

The service provider may have the ability to administer its IP network address space by subdividing the allocated address blocks to smaller subnets, thus, allowing a more efficient use of the service provider's network addresses. From within a block of address space, the service provider may assigns to its customers' subnets addresses based on the customer requirements. This results in the aggregation of many customer routes into a single service provider route, a single route from the perspective of other Internet providers.

Customers may be able to assign non-globally-unique or private addresses to networks under their control. The use by customers of private IP addresses within a VPN community must be transparent to the service provider's network and among member-VPN customer sites. The private addresses may overlap between VPN customer sites within a member VPN community.

The service provider may use border gateway path (BGP) as its edge-to-edge routing protocol. BGP is based on the use of IP addresses, and relies on the assumption that that these IP addresses are unique. Based on this, and given that VPN services are offered, a customer's private addressing scheme may have to be converted into unique addresses for use on the CISP network. This new unique address is referred to as the VPN-IP address. The new VPN-IP address is composed of a 64-bit route distinguisher (RD) plus the customer's network prefix and resides in the VRF table. The RD eliminates the ambiguity and distinguishes between customers using the same IP private addresses within distinct VPNs.

A traditional IP route (static or external border gateway path (EBGP) may be established between the source CE router's interface and the ingress PE router's interface. The ingress PE router converts, for example, by adding the RD to the IP address, the private IP address into the VPN-IP address. Each VPN-IP route is advertised through and distributed opaquely, without regard to the new structure, by IBGP between ingress and egress PE routers. The egress PE router's interface converts the VPN-IP route (static or EBGP) into an IP route for the destination CE router's interface.

The VPN-IP addresses may be carried in the IBGP routing protocol from PE to PE router. The VPN-IP addresses are not in the headers of IP packets and therefore are not directly associated with the forwarding of the packets. Forwarding in the CISP network is based on MPLS.

Network address translation (NAT) provides the address translation for routing traffic between different interconnected networks that use incompatible IP addressing schemes. NAT allows customers with private network addressing schemes to communicate transparently with the CISP network, which also uses private addressing.

NAT enables the CISP network, which uses non-registered IP addresses, to connect to the global Internet. NAT operates on a router or security device and translates between different private or non-globally unique network addresses and between private and global Internet addresses. NAT can be performed at the CE router with the translation of customer addresses into unique addresses bound for the public Internet.

The service provider may configure NAT on the security device to advertise to the outside world one globally-unique address for the entire customer network. The security device converts private addresses in the network into legal addresses before packets are forwarded onto the public Internet. Using one address provides additional security to the network and effectively secures the convergent network from the outside world.

Routing Protocols—Control

The CISP network is an autonomous system (AS) composed of a set of interconnected routers, preferably all managed by the service provider. An AS is defined by a routed network architecture in a contiguous area that is under a single technical and common administrative domain. The domain is a defined service provider network and is a resource that is shared with multiple customer network domains (subnets).

Routers exchanging information within and between interconnected networks use a common routing protocol to route packets. Routing protocols may be used to implement algorithms over interconnected networks and are used by routers to build routing tables. A routing table is a database of interconnected routers, which is created based on the connected links to different parts of the network.

The routing table determines path selection and is used by the forwarding component for the transport of network traffic, such as IP routed traffic, between peering points. To support peering and the routing (or transport) of IP traffic, a common interior gateway protocol (IGP) is used for intra-domain routing. For inter-domain routing static routing or a common exterior gateway protocol (EGP) is utilized to route packets between the network and customer networks.

Routers learn route information in two ways, namely static and dynamic routing. Static routing is imposed by manually entering information into a routing table. A static route uses preset destination and router information, which allows the network administrator to create a controlled or fixed path for traffic forwarding. The static route takes precedence over other routes created or chosen by all dynamic routing protocols. Static routing is preferred when there is only one path connecting between the routers.

In dynamic routing, the routes or transmission paths are automatically learned by the routers via dynamic routing protocols. The IP converged services network may use any suitable routing protocols, such as open shortest path first (OSPF) and interior border gateway protocol (IBGP). Both OSPF and BGP determine explicit routes through the network and then build tables in each router to define the routes. Overlaid onto these routes, using the OSPF and BGP distribution mechanisms, is the virtual private network (VPN) membership and routing information as well as label distribution protocol (LDP) information for MPLS label distribution.

OSPF may be used to maintain routing tables about transmission links within the internal backbone (P and PE routers). BGP may interact and learn routes from the internal routing protocol OSPF. BGP may be used to distribute routes among the set of PE routers that attach to a single OSPF domain. BGP maintains the routing tables between network domains and runs in both PE and CE routers that connect between the CISP network and other network domains. These network domains include directly connected customer subnets and the service provider's connections to the national ISP networks.

Routing Protocols—Forwarding

IP addressing is used to forward traffic in a routed network-and between interconnected routers. The control component of network layer routing—the OSPF and BGP routing protocols—exchanges routing information with all of the interconnected routers and stores this route information in each router's routing table. The routing table and information embedded in the header portion (the IP address label) of an incoming packet is used in the forwarding component. Forwarding is the process of moving a packet from an ingress interface to an egress interface (or input to output) on a router.

The forwarding process involves looking up the forwarding address of the received packet in a router's table to determine how the packet should be treated for forwarding to the next hop (router). Next-hop forwarding in the CISP network is based on multi-protocol label switching (MPLS).

Multi-protocol label switching (MPLS) provides the foundation for provisioning IP-based virtual private networks (VPNs). Transport based on MPLS is a way of imposing onto the shared IP network a dynamic routing path for the fast transport of customer's traffic. These dynamic paths allow the optimization of data flows within the network where traffic is partitioned into the VPNs, commonly known in MPLS terms as label switched paths (LSPs). The LSP is representative of the shared network-based VPN for the aggregation of each service for each customer.

MPLS may be used as a network-based VPN mechanism and also used in conjunction with the interior gateway protocols OSPF and IBGP. OSPF and IBGP may be used to propagate or distribute customer virtual private network (VPN) routing information across the backbone network from PE-to-P and P-to-P routers, using OSPF, and from PE-to-PE routers, using IBGP. When MPLS is used across the backbone network as the edge-to-edge transport or forwarding mechanism, the P and PE routers take on additional, multiple functions and are also known as label switching routers (LSRs). The LSR does label swapping based on a label distribution protocol (LDP). Label swapping involves looking up in a router's label-forwarding table and determining what outgoing label and outgoing port (or interface) is switched or swapped with the incoming label. A label is assigned to a forward equivalence class (FEC), which is related to the network prefix and VPN membership. FEC uses descriptive criteria for forwarding packets of the same likeness along a path, the LSP. The LSP is designated at the time the packet traverses or is forwarded across the network. This is considered an automatic technique (and not explicit traffic engineering) where the label is associated with an LSP. The LSP forms an end-to-end forwarding path beginning at the ingress LSR, passing through one or more core LSRs, and ending at the egress LSR.

The MPLS label-forwarding mechanism may be used to forward packets along the routes that are expressed in terms of addresses residing in packet headers. These addressable routes are associated with either the simple IPv4 address or the extended VPN-IP address information. Labels are attached at the ingress edge network (LSR), where packet headers are examined, and transported across the backbone to the destination or egress edge (LSR) where the labels are stripped off.

MPLS adds labels to the packets to increase the speed of sending traffic through the network by not having routers examine each packet in detail. MPLS implementation in the CISP network may be based on a method that adds two labels or tags to a packet. The labels indicate a certain forwarding behavior that specifies a packet delivery path (LSP) over the network. Each label may be 32-bits and is considered the MPLS shim header located between the layer-3 IP header and the layer-2 data link header.

Security—Customer Edge

An important aspect of the invention is the separation of customer traffic into separate Virtual Private Networks (VPNs) based on service-type at the CE router. A service-provider VPN is limited in terms of which devices can access it. Service-provider VPNs allow for exchange of data between member devices in a more trusted mode, thus avoiding the multiple firewall and encryption boundaries often used to build private networks across the Internet. The network architecture described herein uses different communities of interest. For example, some communities of interest, such as a customer's PDN, may be unlimited in application but specific to an organization. Other communities of interest may be limited by application, for example limited to voice or video traffic, but open to a wide set of different customer organizations.

The customer traffic is separated into its appropriate VPNs as soon as it reaches the CE router, based on the interface accessed by the IP device directing the traffic to the CE router. Since the separation of traffic into its service group takes place immediately, differentiated security and Quality of Service treatment can be applied at the edge of the customer to service provider boundary. This is advantageous for security in that the appropriateness of applications-specific traffic need only be enforced by the service provider at the edge, thus maintaining the uniformity of security policies, and improving reliability. It is, therefore, advantageous for security reasons that the CE router be controlled by the service provider or an agent operating on behalf of the service provider, rather than the customer.

Checking the appropriateness of the incoming traffic at the ingress CE router allows that the security need only be checked once in each direction, increasing speed and scalability. Since “clean” traffic is placed into a specific VPN, best-path routing may be used to any other device on the same VPN. Receiving sites in the VPN may take this traffic directly to their application-specific IP devices. The QoS advantage of immediate separation of traffic at the CE router is that a better trust for QoS can be established. For example, if only VoIP traffic is allowed on a VPN, then it is easier to extend QoS trust for the devices in that VPN: there is a high level of trust for the DiffServ Code Point (DSCP) of information from VoIP devices, because information from other devices is restricted from entering the voice VPN. In another example, there is likewise a high level of trust for video information received into the video VPN, and so information received for transmission onto the video VPN, for example compliant with the H.323 protocol, may be re-classified with new QoS markings as video data.

Information from a particular customer's enterprise data networks, including its workstations, servers and any device that is not to be connected to the shared, voice and video VPNs, enters a general-purpose Private Data Network for that particular customer. The PDN traffic is identified by which logical interface it uses to access the CE. The trust model of a PDN is based on membership in that organization, not on the type of application type, and so customer PDN traffic need not be checked for application-type. This way, the customer is free to use its PDN, on the appropriate private data VPN, for whatever IP data it wishes within its organization. PDN traffic may be checked for basic network security violations such as source-address spoofing but may otherwise be left alone to join the VRF table for that PDN.

QoS for PDNs may be set to appropriate DSCP values. It is important not to allow DSCP markings from the PDN that overlaps, and therefore interferes with, QoS for the voice or video services at that CE site. Shared services, such as voice and video services on their respective shared service VPNs, are different from PDNs, in that the shared services are open to multiple customers, and limited in application type. Like PDN data, information related to communal services, such as voice and video, identifies itself by which interface is used to access the CE router. The VPNs provided by the service provider for the shared services, for example the video and voice VPNs, may be maintained to be separate from each other so that a security problem on one shared service VPN does not harm the other.

Allowing VoIP devices from different customer organizations into one voice VPN requires a level of security and trust which ensures that one customer's voice-connected devices do not compromise the security of another's voice devices, or of the shared voice and video services. Some policies that may be used to ensure this level of security include:

1. By virtue of having only VoIP devices attached, the voice VPN may be built to be only of interest for voice, and not usable for other IP traffic types.

2. Only those traffic patterns recognizable by the CE router as being appropriate for VoIP communication are allowed into the voice VPN, all other traffic presented to the CE router on the logical voice port being discarded and/or flagged for review.

3. A customer may keep its VoIP devices on different logical networks, for example, VLANs in Ethernet topologies, from the rest of its corporate network. This ensures that a security compromise on the customer's PDN or voice network is isolated in scope.

4. The customer may be assured that the service provider is restricting other customers' access to the shared voice network and will only allow VoIP-appropriate traffic into the network.

QoS trust allows VoIP devices to mark their its bearer traffic and signaling for priority queuing and guaranteed bandwidth, respectively, which leads to high voice quality and reliability. The number of simultaneous VoIP calls made from the CE site to the PE router may be limited by the bandwidth pre-provisioned on the local access loop, thus providing the needed bandwidth to the voice traffic without allowing it to starve other traffic classes of service.

A customer's video devices, such as H.323 devices, have a similar service to voice: there is a dedicated VPN only for carrying video traffic. In one embodiment, the traffic entering the video VPN may be restricted to only that traffic complying with the H.323 protocol. The video VPN may have policies that allow a trust of video traffic through the video-specific VPN:

1. The video VPN may be made for, and only provides access to, video-conferencing devices.

2. Only those traffic patterns recognizable by the CE router as being appropriate for H.323 video-conferencing traffic, and/or some other video data protocol, may be allowed into the video VPN, with all other incoming traffic being discarded and/or flagged for review.

3. A customer may keep its video-conferencing devices, such as H.323 devices, on different logical networks, such as VLANs in Ethernet topologies, for the rest of its corporate network. This reduces in scope the issues stemming from a security compromise on its PDN or video-conferencing network.

4. A customer may be assured that the service provider is restricting other customers' access to the shared video VPN and will only allow video-conferencing-appropriate traffic into the video VPN.

The same knowledge of video protocol types used to provide security may be re-used to apply QoS. Packets entering the CE from customer video devices may be classified and re-marked with appropriate QoS markings. Not only does this prevent misconfigured customer video devices from hampering the quality of video services on the video VPN, it also ensures that video-conferencing QoS does not overlap with that of voice.

Security Device

The security device may perform packet filtering and allow inbound and outbound access to and from the public Internet: the security device may be used to manage the connections to the Internet. Security device filtering adds a level of security to the network and protects against unwanted ingress and/or egress on the customer's subnet.

The use of a centralized security device may provide secure connectivity between the customer PDN-VPN sites trying to reach Internet destinations off-net and, conversely, between Internet sources trying to reach the on-net PDN-VPN sites. The security device may serve as one endpoint for the PDN-VPN service, the other endpoint being a VLAN interface at the customer edge. The logical interface may be based on the MAC address/interface and VLAN tagging, which is associated with a customer VPN IP address. Private IP addresses may be translated by the security device, which does network address translation (NAT), so inbound and outbound Internet traffic is routed securely on the CISP network and between the source VPN sites and destination sites on the public Internet.

Network Management

In-band means network management activity is conducted within the IP transport network itself. Management traffic travels within and shares the same uplink path or channel, for example, OC-12 POS circuit, as the customer VPN traffic and allows access to the IP equipment, the routers, for example, via the bandwidth configured in the IP transport network. Management traffic travels within the management VPN that is configured across the network using the multiple QoS techniques that were outlined above.

Two in-band management protocols that may be used for the particular embodiment of the CISP network include simple network management protocol (SNMP) and Secure Shell (SSH). SNMP provides normal, day-to-day network monitoring, performance metrics and alarm reporting during regular network operations. SSH sets up communication sessions and may be used to permit users to login remotely from the router via a PC or a management terminal/console.

Out-of-band management functionality complements SNMP and SSH and provides an alternative path for device or network element management. When the network and the in-band management system are not functioning correctly or are down, an out-of-band management system allows technicians and network administrative personnel to have direct connections to the problematic device for maintenance and troubleshooting.

The out-of-band management (OBM) network is an independent or standalone subnet that supports the CISP network devices as well as other network devices associated with other embedded networks. The OBM network is associated with two components: the multiple management devices (network equipment) and the connecting links.

Service Level Agreement Network Monitoring

The service provider may monitor network services in order to meet certain performance requirements. This monitoring capability relates to providing customers with the Service Level Agreements (SLAs) that are associated with the subscribed convergent services. Such an SLA may cover what type of services a user is subscribing to, for example voice, video and private data, and what bandwidth is available to the customer for each service. For example, under an SLA, a customer may be provided with bandwidth for a certain number of voice calls over the voice VPN, or a certain number of video calls over the video VPN.

A Service Assurance Agent (SM), may be embedded in the router software. SM provides a solution for service level monitoring by providing the monitoring capability in a router. The SM collects metrics or network performance information in real time. Such data may include application response or connection time, application availability, packet latency, packet jitter, packet loss, as well as other network statistics. The SM may provide the mechanism to monitor performance for different classes or types of traffic over the same access connection and across the wide area network.

The service provider may deploy the SM solution for full-mesh network monitoring and measuring. Full-mesh means that a shadow router is deployed next to each of the connected PE routers. To monitor and track metrics in the network on a hop-by-hop basis and end-to-end from PE router to PE router (via each hop in the backbone IP network), the service provider may emulate a customer end-site and a shared WAN through the use of the connected shadow routers. The shadow routers are dedicated to SM use to reduce the resource impact on the production network by off-loading the SM monitoring process overhead from the primary PE router.

The shadow router may connect to the PE router via a T-1/DS-1 link to simulate the customer network. The shadow router may connect indirectly, like customer sites, via a physical T-3/DS-3 and a DS-1 logical link to the PE router deployed in CISP PoP.

SM Operation

To simulate the type of service connectivity to its customers, the service provider may not only emulate the layer-1 connectivity, but may also utilize the layer-2 (DLCI/PVC or frame relay encapsulation) and layer-3 (DSCP) components described earlier. At layer-3, SM is configured to monitor CoS traffic over the same T-1 access link by specifying the use of the DSCP or IP precedence bits in the IP packet header. The service provider may then synthesize IP packet traffic across the network. The synthesized traffic may be sent or generated at regular intervals, for example every five minutes, by the PE routers and allows the service provider to measure performance continuously over time on its backbone network. The SM operation may use a probe, that is a task to take the measurement based on the performance metrics of jitter, packet delivery, network availability and latency.

As noted above, the present invention is applicable to communications networks and is believed to be particularly useful for communications networks that provide converged services to customers, including, but not limited to, voice, video and private data services. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. A method of providing a communications system to a plurality of customers, comprising:
providing, on a communications network, at least one shared service virtual private network (VPN) accessible by a first set of customers for a shared service, permitting communication between users of different customers subscribed to that service; and
providing, on the communications network, at least one private data VPN for handling private customer information, the at least one private data VPN being associated With a respective customer.

2. A method as recited in claim 1, wherein the at least one shared service VPN is a voice VPN for sharing voice communications between users of different customers on the voice VPN.

3. A method as recited in claim 2, further comprising providing access from the voice VPN to a public switched telephone network (PSTN), a user on the voice VPN making a voice communication with a recipient not a user on the voice VPN through the PSTN.

4. A method as recited in claim 2, further comprising providing call control services for controlling voice communications between users of different customers on the voice VPN.

5. A method as recited in claim 4, further comprising connecting the call control services to the voice VPN through at least one security device.

6. A method as recited in claim 2, further comprising checking that information, before entering the voice VPN, complies with a voice communications protocol.

7. A method as recited in claim 6, wherein the checking takes place at a customer edge (CE) router connecting one of the customers to the communications network.

8. A method as recited in claim 6, wherein the information originates at a user connected to the voice VPN through a PSTN and further comprising carrying out the checking at a security device connected between the PSTN and the voice VPN.

9. A method as recited in claim 1, wherein the at least one shared service VPN is a video VPN for sharing video communications between users of different customers on the video VPN.

10. A method as recited in claim 9, further comprising providing gatekeeper services for video communications on the video VPN.

11. A method as recited in claim 9, further comprising providing multi-point control services for controlling video conferences between at least one user on the video VPN and at least one other video user.

12. A method as recited in claim 9, further comprising checking that information, before entering the video VPN, complies with a video communications protocol.

13. A method as recited in claim 9, wherein the checking takes place at a CE router connecting one of the customers to the communications network.

14. A method as recited in claim 9, wherein the information originates at a user connected to the video VPN through a multi-point control unit (MCU) and further comprising carrying out the checking at at least one a security device connected between the MCU and the video VPN.

15. A method as recited in claim 1, wherein the at least one shared service VPN includes a voice VPN for sharing voice communications between users of different customers and includes a video VPN for sharing video communications between users of different customers.

16. A method as recited in claim 1, further comprising managing routers on the communications network via a common management VPN.

17. A method as recited in claim 1, wherein the communications network is an IP network.

18. A method as recited in claim 17, further comprising identifying at a CE router which VPN, of the at least one shared service VPN and the at least one private data VPN, an IP packet is to be put onto at a provider edge (PE) router.

19. A communications system for providing communications services to a plurality of customers, comprising:
a communications network configured with
at least one shared service virtual private network (VPN), at least a first set of customers being connected respectively to the at least one shared service VPN for sharing a respective service on the at least one shared service VPN, and
at least one private data VPN for handling private customer information, the at least one private data VPN being associated with a respective customer.

20. A system as recited in claim 19, wherein the communications network transmits information using Internet Protocol (IP)

21. A system as recited in claim 19, wherein the network comprises a network backbone formed among provider (P) routers, with provider edge (PE) routers connecting off the network backbone, customer sites being connected to the PE routers via respective customer edge (CE) routers connected to at least one of the PE router.

22. A system as recited in claim 19, wherein the at least one shared service VPN is a voice VPN for sharing voice communications between users of different customers on the voice VPN.

23. A system as recited in claim 22, wherein the voice VPN is connectable to a public switched telephone network (PSTN) so that a user on the voice VPN is connectable, for voice communication, with a recipient not a user on the voice VPN.

24. A system as recited in claim 23, wherein the PSTN is connectable to the voice VPN via at least one security device.

25. A system as recited in claim 22, wherein the voice VPN is connectable to the Internet via at least one security device.

26. A system as recited in claim 22, further comprising a call controller connected to the voice VPN for controlling voice communications between different users on the voice VPN.

27. A system as recited in claim 26, wherein the call controller is connected to the voice VPN via at least one security device.

28. A system as recited in claim 19, wherein the at least one shared service VPN is a video VPN for sharing video communications on the video VPN.

29. A system as recited in claim 28, further comprising a gatekeeper connectable to the video VPN.

30. A system as recited in claim 29, wherein the gatekeeper is connectable to the video VPN via at least one security device.

31. A system as recited in claim 28, further comprising a multi-point control unit (MCU) connectable to the video VPN for controlling video conferences involving at least two video units.

32. A system as recited in claim 31, wherein the MCU is connectable to the video VPN via at least one security device.

33. A system as recited in claim 28, wherein the video VPN is connectable to a PSTN via an MCU so that a user on the video VPN is connectable with a video recipient not on the video VPN.

34. A system as recited in claim 28, wherein the video VPN is connectable to the Internet via at least one security device so that a user on the video VPN is connectable with a video recipient not on the video VPN.

35. A system as recited in claim 19, wherein the at least one shared service VPN includes a voice VPN for sharing voice communications between users of different customers and includes a video VPN for sharing video communications between users of different customers.

36. A system as recited in claim 19, wherein the communications network is configured with a common management VPN.

37. A system as recited in claim 19, wherein customer sites are connected to the communications network via CE routers connected to at least one PE router, the CE routers being connected to the common management VPN via the at least one PE router.

38. A system as recited in claim 19, wherein the at least one shared service VPN is connected to a central services VPN via at least one security device, services used by users of the at least one shared service VPN being connected to the central services VPN.

39. A system as recited in claim 38, wherein the at least one shared service VPN is connected to the central services VPN via a common access VPN, the common access VPN being connected to the central services VPN via the at least one security device.

40. A system for providing centralized services to customers on a converged service network, comprising:
a communications network configured with
at least one shared service virtual private network (VPN) accessible by multiple customers to receive a service in a shared environment on the converged service network; and
a central services VPN, common service units being connected to the central services VPN, the central services VPN being connected to the at least one shared service VPN via at least one security device.

41. A system as recited in claim 40, the network further configured with a common access VPN connected between the at least one security device and the at least one shared service VPN, information flow between the at least one shared service VPN and the central services VPN passing through the common access VPN.

42. A system as recited in claim 41, wherein the at least one shared service VPN includes at least two shared service VPNs and the common access VPN is configured to prevent information flow, within the common access VPN, between one of the at least two shared service VPNs and another of the at least two shared service VPNs.

43. A system as recited in claim 40, wherein the at least one shared service VPN includes a shared voice VPN, and wherein the common services units include at least one call control unit.

44. A system as recited in claim 40, wherein the at least one shared service VPN includes a shared voice VPN, and wherein the common services units include at least one public switched telephone network (PSTN) gateway unit.

45. A system as recited in claim 40, wherein the at least one shared service VPN includes a shared video VPN, and wherein the common services units include at least one multi-point control unit (MCU).

46. A system as recited in claim 40, wherein the at least one shared service VPN includes a shared video VPN, and wherein the common services units include at least one video gatekeeper unit.

47. A system as recited in claim 40, wherein the at least one shared service VPN includes a shared voice VPN and a shared video VPN.

48. A system as recited in claim 40, wherein the communications network is further-configured with a common management VPN, routers on the communications network being managed through the common management VPN.

49. A system as recited in claim 40, wherein the customers connect to the communications network via respective CE routers connected to at least one PE router, the CE routers being connected to the common management VPN via the at least one PE router.

50. A system as recited in claim 40, wherein the communications network communicates using the Internet Protocol (IP).

51. A method for providing centralized services to customers on a converged service, communications network, comprising:
providing at least one shared virtual private network (VPN) accessible by multiple customers to receive a service in a shared environment on the converged service network;
providing a central services VPN;
connecting common service units to the central services VPN; and
connecting the central services VPN to the at least one shared service VPN via at least one security device.

52. A method as recited in claim 51, connecting the at least one shared service VPN to a common access VPN and connecting the common access VPN to the central services VPN via the at least one security device so that information flows from the at least one shared service VPN, through the common access VPN and to the central services VPN.

53. A method as recited in claim 52, wherein the at least one shared service VPN includes at least two shared service VPNs, and further comprising preventing information flow, within the common access VPN, between one of the at least two shared service VPNs and another of the at least two shared service VPNs.

54. A method as recited in claim 51, wherein the at least one shared service VPN includes a shared voice VPN, and further comprising providing call control services over the central services VPN to the shared voice VPN.

55. A method as recited in claim 51, wherein the at least one shared service VPN includes a shared voice VPN, and further comprising connecting a user on the shared voice VPN to an off-network user via the central services VPN and at least one PSTN gateway unit connected to the central services VPN.

56. A method as recited in claim 51, wherein the at least one shared service VPN includes a shared voice VPN, and further comprising connecting a user on the shared voice VPN to the Internet via at least one Internet security device.

57. A method as recited in claim 51, wherein the at least one shared service VPN includes a shared video VPN, and further comprising controlling a video conference among at least two video units, at least one of the at least two video units being connected to the video VPN.

58. A method as recited in claim 51, wherein the at least one shared service VPN includes a shared video VPN, and further comprising connecting a user on the shared video VPN to the Internet via at least one Internet security device.

59. A method as recited in claim 51, wherein the at least one shared service VPN includes a shared video VPN, and further comprising providing at least one of video administration services, video registration services and video admission control services.

60. A method as recited in claim 51, wherein the at least one shared service VPN includes a shared voice VPN and a shared video VPN, and further comprising providing shared voice services on the shared voice VPN and providing shared video services on the shared video VPN.

61. A method as recited in claim 51, further comprising managing routers on the communications network via a common management VPN.

62. A method as recited in claim 61, wherein customers are connected to the communications network via CE routers connected to at least one PE router, further comprising managing the CE routers via the common management VPN.

63. A system for connecting a customer to a communications network, comprising:
a customer edge (CE) router;
a provider edge (PE) router; and
a connection between the CE router and the PE router;
wherein the CE router is configured to select a VPN over which an IP packet received from the customer is to travel, the CE router selecting from i) at least one shared service virtual private network (VPN) connected to the PE router and configured for providing a shared service to multiple customers on the communications network and ii) a private data VPN (PD-VPN) connected to the PE router.

64. A system as recited in claim 63, wherein the connection is a local access connection.

65. A system as recited in claim 63, wherein the CE router is provided with at least two logical interfaces, the logical interfaces being associated with respective VPNs connected to the PE router, the CE router selecting the VPN based on which-logical interface the IP packet arrived at the CE router.

66. A system as recited in claim 65, wherein at least one of the logical interfaces associated with the at least one shared service VPN has an associated respective security policy and IP traffic passing through the at least one logical interface conforms to the respective security policy.

67. A system as recited in claim 63, wherein the connection between the CE router and the PE router is configured with generic routing encapsulation (GRE) tunnels between respective first logical interfaces in the CE router and respective second logical interfaces in the PE router.

68. A system as recited in claim 67, wherein the second logical interfaces are in respective virtual routing and forwarding (VRF) tables associated respectively with the at least one shared service VPN and the PD-VPN.

69. A system as recited in claim 67, wherein the at least one shared services VPN includes a shared voice VPN, and a voice GRE tunnel is connected to a voice second logical interface in the PE router, the voice second logical interface being in a voice VRF table.

70. A system as recited in claim 67, wherein the at least one shared services VPN includes a shared video VPN, and a video GRE tunnel is connected to a video second logical interface in the PE router, the video second logical interface being in a video VRF table.

71. A system as recited in claim 67, wherein a private data GRE tunnel is connected to a private data second logical interface in the PE router, the private data second logical interface being in a private data VRF table.

72. A system as recited in claim 63, wherein the CE router is configured with Frame Relay data link control identifiers (DLCIs) associated with the at least one shared service VPN and the PD-VPN respectively.

73. A system as recited in claim 72, wherein the at least one shared service VPN includes a shared voice VPN, and a voice IP packet received in the CE router from the customer is carried on a voice DLCI to the PE router, the voice DLCI being on a voice VRF associated with the shared voice VPN.

74. A system as recited in claim 72, wherein the at least one shared service VPN includes a shared video VPN, and a video IP packet received in the CE router from the customer is carried on a video DLCI to the PE router, the video DLCI being on a video VRF associated with the shared video VPN.

75. A system as recited in claim 72, wherein a private data IP packet received in the CE router from the customer is carried on a private data DLCI to the PE router, the private data DLCI being on a private data VRF associated with the PD-VPN.

76. A system as recited in claim 63, wherein the PE router is on a common management VPN for managing the PE router.

77. A system as recited in claim 76, wherein the CE router is connected to the common management VPN via the connection.

78. A method of connecting a customer to a communications network having at least one shared service virtual private network (VPN) for providing a shared service to multiple customers and a private data VPN (PD-VPN), the method comprising:
selecting a VPN from i) at least the one shared service virtual private network (VPN) connected to a PE router and configured for providing a shared service to multiple customers on the communications network and ii) a private data VPN (PD-VPN) connected to the PE router; and
directing IP traffic to the selected VPN.

79. A method as recited in claim 78, wherein directing the IP traffic includes directing the IP traffic over a local access connection.

80. A method as recited in claim 78, selecting the VPN includes determining which logical interface of a plurality of logical interfaces the IP traffic arrives at, and selecting the VPN based on the determined logical interface.

81. A method as recited in claim 80, wherein at least one of the logical interfaces is associated with a respective security policy and further comprising restricting IP traffic passing through the at least one of the logical interfaces to IP traffic conforming to the respective security policy.

82. A method as recited in claim 78, further comprising associated generic routing encapsulation (GRE) tunnels between respective first logical interfaces in a CE router and respective second logical interfaces in a PE router, and directing the IP traffic along a selected GRE tunnel.

83. A method as recited in claim 82, wherein the GRE tunnels are associated with respective VRF tables, the VRF tables being associated with different VPNs, and further comprising directing the IP traffic in the PE router to the selected VPN using the VRF table associated with the GRE tunnel on which the IP traffic is directed.

84. A method as recited in claim 82, wherein the at least one shared service VPN includes a shared voice VPN, and a voice GRE tunnel is connected to a voice second logical interface in the PE router, and further comprising directing voice IP traffic in the CE router along the voice GRE tunnel.

85. A method as recited in claim 82, wherein the at least one shared service VPN includes a shared video VPN, and a video GRE tunnel is connected to a video second logical interface in the PE router, and further comprising directing video IP traffic in the CE router along the video GRE tunnel.

86. A method as recited in claim 82, further comprising directing private data IP traffic in the CE router along a private data GRE tunnel to the PE router.

87. A method as recited in claim 78, further comprising configuring a CE router with Frame Relay data link control identifiers (DLCIs) associated with the at least one shared service VPN and the PD-VPN respectively.

88. A method as recited in claim 87, wherein the at least one shared service VPN includes a shared voice VPN, and further comprising directing voice IP traffic received in the CE router on a voice DLCI to the PE router, the voice DLCI being on a voice VRF associated with the shared voice VPN.

89. A method as recited in claim 87, wherein the at least one shared service VPN includes a shared video VPN, and further comprising directing video IP traffic received in the CE router on a video DLCI to the PE router, the video DLCI being on a video VRF associated with the shared voice VPN.

90. A method as recited in claim 87, further comprising directing private data IP traffic received in the CE router on a private data DLCI to the PE router, the private data DLCI being on a private data VRF associated with the PD-VPN.

91. A method as recited in claim 78, further comprising managing the CE and PE routers via a common management VPN.

92. A method of directing IP traffic from a customer onto a communications network configured with at least one shared service virtual private network (VPN) and at least one private data VPN (PD-VPN), the method comprising:
determining which VPN the IP traffic is to be directed to from i) the at least the one shared service VPN and ii) a private data VPN (PD-VPN); and
applying quality of service (QoS) rules to the IP traffic based on the determined VPN.

93. A method as recited in claim 92, wherein applying quality of service rules includes applying class of service (CoS) priority to the IP traffic.

94. A method as recited in claim 93, wherein applying CoS to the IP traffic includes applying differentiated services to the IP traffic.

95. A method as recited in claim 93, wherein applying CoS to the IP traffic includes applying integrated services to the IP traffic.

96. A method as recited in claim 93, wherein applying CoS to the IP traffic includes marking the IP traffic based, at least in part, on the amount of other IP traffic currently present.

97. A method as recited in claim 93, wherein applying CoS to the IP traffic includes marking the IP traffic based, at least in part, on bandwidth partitions for different types of IP traffic.

98. A method as recited in claim 92, wherein the determining step includes determining on which logical interface the IP traffic arrives from the customer.

99. A method as recited in claim 92, further comprising applying the QoS rules at a customer edge (CE) router connecting the customer to the communications network.

100. A communications system providing converged IP services to customers, the system comprising:
a communications network configured with at least one shared service virtual private network (VPN) for providing a shared service a first set of the customers and at least one private data VPN (PD-VPN) for carrying private data of at least one respective customer,
the network including at least one customer edge (CE) router configured to determine which VPN, from i) the at least the one shared service VPN and ii) a private data VPN (PD-VPN), IP traffic received from an associated customer is to be directed to, the CE router further being configured to apply quality of service (QoS) rules to the IP traffic based on the determined VPN.

101. A system as recited in claim 100, wherein the CE router is further configured to determine which VPN the IP traffic is to be directed to based, at least in part, on which logical interface the IP traffic arrived from the customer.

102. A system as recited in claim 100, wherein the CE router is further configured to apply class of service (CoS) priority to the IP traffic.

103. A system as recited in claim 100, wherein the CE router is further configured to apply differentiated services to the IP traffic.

104. A system as recited in claim 100, wherein the CE router is further configured to apply integrated services to the IP traffic.

105. A system as recited in claim 100, wherein the CE router is configured to mark the IP traffic based, at least in part, on the amount of other IP traffic currently passing through the CE router to a PE router connected to the CE router.

106. A system as recited in claim 100, wherein the CE router is configured to mark the IP traffic based, at least in part, on bandwidth partitions for different types of IP traffic.
